(19) United States
(12) Patent Application Publication
(10) Pub. No.: US 2002/0033134 A1
(43) Pub. Date: Mar. 21, 2002

(54) Method and apparatus for processing coatings, radiation curable coatings on wood, wood composite and other various substrates

(76) Inventor: Mark G. Fannon, Shelby Township, MI (US)

Correspondence Address: Mark G. Fannon, 2497 King's Cross, Shelby Township, MI, 48316-1210, US

(21) Appl. No.: 09/950,485

(22) Filed: Sep. 10, 2001

Related U.S. Application Data
(60) Provisional application No. 60/233,277, filed on Sep. 18, 2000.
(60) Provisional application No. 60/255,055, filed on Dec. 11, 2000.

(51) Int. Cl. B05C 5/00

(52) U.S. Cl. 118/667; 118/723 R; 118/724

(57) ABSTRACT

A method and apparatus that combines the coating spray booth with process heating and radiation to increase the efficiency of the processing of powder coatings on wood, wood-based composite materials and plastic substrates. The temperature of the parts in process can be maintained within the booth after preheating or elevated in temperature within the booth before, during, and after the application of the coating material. The invention allows for the control of the rate of thermal expansion of heat sensitive materials, thereby reducing substrate damage from cracking. Increased efficiencies permit a significant reduction of processing energy expense. Multiple coatings can be applied and cured to parts in process within the invention while experiencing an overall reduction in the length of the processing system compared to the prior art.

### TECHNICAL FIELD

The present invention relates to a method and apparatus that safely combines the coating spray booth with infrared radiant process heating to increase the efficiency of processing coatings on temperature sensitive substrates, such as wood, wood-based materials, and plastics. The terms “temperature sensitive” refers to objects that possess a low rate of thermal conductivity and/or a relatively high thermal expansion factor. The application of ultraviolet radiation can also be safely combined with the spray booth equipment for efficiently processing ultraviolet curable coatings. The invention provides a method and apparatus to safely maintain, increase and control the surface temperature of objects in process while in the spray booth before, during and after the application of the coating material upon the objects. The invention also provides a method and apparatus to safely control the coefficient of thermal expansion of the objects in order to avoid physical damage to temperature sensitive substrates during processing within the invention.

### BACKGROUND OF INVENTION

Coatings have been installed upon the surfaces of many materials for a variety of reasons, including appearance, protection, durability, and the modification of surface friction. These coatings have been applied in liquid form, such as waterborne and solvent based paints, or in solid form, such as thermoplastic and thermosetting powder coatings. Traditional methods and apparatus for the pretreatment, application, and drying/curing of said coatings have involved separate and individual machinery for each step of the process.

The powder coating process often requires the preheating and/or post-heating of the object to be coated with an oven system. The oven may be of the radiant infrared type, convection, or a combination of hot air and radiation. The oven system may generate its thermal energy by way of electricity, combustion, or a combination of the two. After preheating, the parts to be coated may travel a significant distance, then enter a spray booth by means of an indexing or continuously moving conveyor.

The powder spray booth is a separate and distinct device from the preheating oven. It is comprised of an enclosure that is supplied with clean filtered air. The powder spray booth also contains the powder spray application equipment. Commonly called a spray gun, this device can be manually or automatically operated. The powder spray gun can be of the electrostatic corona type or the tribo type. The powder exits the gun, forming a cloud of powder that is attracted to the part in process due to differences in electrostatic charge. The part is commonly earth grounded with a strategic ohm resistance between earth ground and the grounded target object, typically no more than 1 mega-ohm of resistance. The electrostatically charged powder paint particles possess either positive or negative static values, causing the powder coating to temporarily adhere to the grounded surface. An exhaust system within the spray booth actually reclaims the powder overspray and deposits it back into the appropriate powder supply container. Efficient filtration of the powder minimizes the contamination of the reclaimed powder from other particulate matter.

After processing in the powder spray booth, the parts will again travel a significant distance to another separate radiant and/or convection oven system. This heat cause the powder to coalesce, liquefy, and cross-link, provided the powder is a thermosetting coating that contains a thermally curing catalyst. If the powder paint is of the ultraviolet curable type, it must then be processed with significant quantities of ultraviolet (UV) radiation. The UV is applied after the powder coating has coalesced and adequate flow out has occurred. The UV radiation acts upon a chemical known as a photoinitiator, which acts as a catalyst for the cross-linking of atoms in the UV curable thermosetting powder materials.

Two organizations, known as the National Fire Protection Agency (NFPA) and the National Equipment Manufacturers Association (NEMA), impose stringent regulations upon the traditional paint processing system for design and operation. The spray booth, whether for liquid or powder coatings, has been classified as a hazardous area that is subject to explosion. Therefore, other separate processing equipment systems, such as gas and electric process heating equipment and ultraviolet radiation devices, have been prohibited from occupying the same area as the spray booth. Ovens and other separate radiation emitting equipment devices must currently maintain a minimum distance of five (5) feet from the spray booth in order to meet current regulations for safe operation.

Recent advancements have occurred in the development of thermal and UV curable powder coatings that are intended for installation upon low temperature substrates, such as wood, wood-based, and plastic substrates. Examples of the wood substrate materials are MDF (medium density fiberboard), low and high density wood composite material, and fully grained pine and hardwoods. Since these materials are electrically non-conductive, there are difficulties associated with the consistent earth grounding of the wood that is critical for the electrostatic spraying process. The rapid and initial heating of the wood substrate surface to be coated causes trace amounts of moisture to be expelled from the surface. A thin layer of moisture is then present upon the surface of the wooden substrate, which acts as the electrical conductor for strategic connection to earth ground. However, this critical moisture layer is only present for a short period of time. The longer the time interval between the pre-heat oven equipment and the powder spray equipment, the lesser is the presence of the moisture layer. The dry ambient atmosphere naturally absorbs the moisture layer as it travels through time and space to the powder application equipment. Further, the moisture that has risen to the target surface is in limited supply, even though significant quantities of moisture still reside within the substrate. Once the surface moisture has been expelled, the moisture at deeper levels within the wood substrate requires substantial migration time to wick its way to the recently dried surface. Therefore, the quantity of available moisture that can be rapidly driven to the surface is in very low supply.

Thin recessed areas in wood substrates pose unique moisture problems. An example of such a target substrate is a wooden six panel door. The moisture content of the thin wooden areas can be less than the substantially thicker adjacent wood structures. Exposure to dry air over time causes the thin areas to lose their moisture faster than the thick areas. This is true because the thin wood contains less mass, therefore, less moisture. Since the moisture is released to the environment from both thin and thick wooden surfaces at similar rates, it becomes evident that the less massive areas will be drained of their limited moisture first, and the heavy areas last. This is due to a common moisture migration rate through the wood substrate, where the total available moisture content is the variable, primarily because the more massive areas represent a larger container in which the moisture can reside. This can be compared to the amp hour ratings of two similar voltage batteries. Two batteries may both be considered 12 volt batteries, however, one may be rated at 100 amp hours, and the other at 50 amp hours. Initially, both devices will discharge the same voltage, but the larger battery will require more time to completely drain. Likewise, thick and thin wood areas disperse their moisture at the same rate at first, but the thicker areas have a greater moisture reserve. In time, this can result in significant differences in total available surface moisture content. This difference becomes greater with the passage of time, but returns to a similar moisture percentage content after all surfaces are considered to be in reasonable equilibrium with the surrounding environment. Unfortunately, the moisture content is typically in the range of greatest dissimilarity when it is desirable to powder coat the wood substrate in question.

Varying substrate thickness occurs for a variety of reasons. Often, the thin areas are formed for decorative reasons. These can be the decorative grooves that have been placed in cabinet doors, thin decorative door panels, or structural requirements that are necessary for final assembly of the particular wood product. The unreliably uniform moisture content in the varying wood thickness has prevented the successful powder coating application of many material objects. This problem is a major inhibitor to the future success of powder coatings on many non-conductive wood products.

A short time interval between the preheating of the substrate and the application of the powder coating material has become highly desirable. Powder processing system designs currently adhere to the “separate equipment” mentality, and are burdened with unfavorable time lags between the heat processes and the application of the powder material to the substrate. This is due to the significant distances that the parts in process must travel between separate pieces of processing equipment. The same holds true for post-heat and other subsequent processes that follow the powder booth application process.

In some instances, the wood substrate to be powder coated is heated in a convection oven to perform the preheat function. However, the substrate experiences a rapid surface temperature drop during its travel through time and space before the powder is actually applied. To compensate for this situation, the substrate has been heated to a significantly higher than ideal temperature prior to the actual application of the powder material. This heating method is in anticipation of the thermal degradation that has historically occurred on the substrate surface when traveling from the exit of the oven to the powder spray application equipment. Therefore, after the rapid cooling has occurred, the surfaces to be coated have dropped to the approximate surface temperature that is ideal for the application of the powder coating. This procedure causes a variety of problems for maintaining uniformity of temperatures over the substrate surface. It can also cause an undesirable depletion of moisture, as well as the expulsion of natural wood resins (sap), from some substrates.

Current safety regulations have banned the installation of gas and electric heaters and electric UV radiation devices within the spray booth. It is desirable to place IR and UV processing equipment in extremely close proximity to the actual powder spray cloud in order to minimize the existing lag time between the preheat process and the deposition of the powder material to the substrate. Radiation that is simultaneously applied to the wood substrate (or nearly so) during the application of the powder coating is highly desirable. There has been a need for the inclusion of process radiation in the spray area in order to apply the powder immediately after attaining the target temperature on the surface of the substrate. This would permit the application of the powder coating at an ideal time, when trace moisture has migrated to the surface of the wood substrate and is in rich supply before it has a chance to dissipate to the environment. This moisture provides the conductive means to electrically connect the non-conductive substrate with earth ground (or other magnetic and/or electromagnetic and/or electrostatic energy) which is critical to the electrostatic coating equipment process.

A strong need exists for the integration of separate processing apparatus that combines process radiation equipment (IR/UV) with the spray booth, but in a means that is acceptably safe to the aforementioned regulatory agencies. The purpose of combining these separate devices is to achieve process improvements that have been minimized or lost to the environment because of process travel time between separate pieces of equipment and for the conservation of energy.

It is a specific objective to preserve the moisture layer between the initial heat up (and subsequent moisture release from the substrate) and the application of the powder. The moisture layer that is expelled from the surface of the substrate to be powder coated is in its richest supply during the initial heat up, and shortly thereafter. Therefore; the greatest electrical conductivity exists on the surface of the substrate only moments after the initial expulsion of moisture from its non-conductive host. Great advantages can be gained by immediately applying the powder during the presence of the moisture laden layer in a reasonably rich form. This invention addresses the problem of moisture rapidly dissipating to the environment by integrating the radiation heat process with the powder coating booth and powder application so that the powder can be immediately applied at the most opportune moment in the process. Minimizing substrate travel through time and space helps to preserve the moisture layer and improve the successful powder application and curing processes.

The invention also addresses the problem of low moisture in the relatively thin wood areas. When the moisture content is unacceptably low in the thinner areas, primarily because it has been naturally depleted through exposure to the environment, it can be temporarily supplied to the substrate as part of the invention process. The invention calls for the application of controlled moisture laden fluid (often condition air) onto the subject part. Using a six panel door as an example, the thin areas are often recessed areas. The door can be strategically coated with moisture laden fluid of reasonably reduced temperature. The cool fluid is of higher density, and therefore possesses greater physical weight than the ambient air in which the substrate resides during the powder application process. The cool fluid is extruded onto the substrate (assuming flatline processing), where it displaces the warmer air in the groove areas. The heavy moisture controlled fluid will remain intact within the groove area because of its own weight. The cooler moisture controlled fluid may be ionized, positively or negatively charged, or may be electrostatically neutral. An agent, typically gaseous, may be added as an electrolyte in order to modify the electrical resistance of the fluid, relative to the ambient processing atmosphere.

The application of the cool moisture controlled fluid is applied at approximately the same velocity as the conveyorized substrate. This could be compared to the application of toothpaste onto a toothbrush. The application of the extruded chilled fluid need not move faster or slower than the movement of the substrate on which it will reside. Therefore, the supply rate during application of the cooler moisture laden fluid can be in agreement with the demand quantity requirement from the substrate. In some cases, the part in process may pass under a spreader bar that will trowel off the cooler fluid from the massive areas, leaving the cooler moisture laden fluid to reside in the grooved areas where it is needed. This squeegee effect creates a uniform moisture layer on the substrate, where the cooler moisture laden fluid successfully compensates for the lack of moisture content in the prematurely dried thin grooved areas. The result is a reasonably uniform surface moisture layer that facilitates an electrical connection to ground, or other positive or negatively charged electrical medium. This strategically enhanced uniformity may modify the Faraday Effect.

The ideal moisture content within the substrate before processing is commonly believed to be 4% to 8% by weight. The moisture controlled chilled fluid may contain higher levels of relative humidity than the moisture layer that is created by the driving out of moisture from the substrate from heat processing. This is due to the difference in temperature of the cooler fluid and the heat process driven moisture layer. Cooler fluid cannot hold the same maximum quantity of water vapor as warmer air. Therefore, the cooler fluid may contain similar quantities of moisture as the warmer moisture layer, but in terms of relative humidity, the percentage of moisture content may differ than that of the warmer air. The relative humidity of the cooler fluid may be adjusted to be higher, lower, or the same as that of the warmer moisture layers that will occupy the heavier wood members. The desired relative humidity level is adjustable and dependent on other process variables. The cooler moisture controlled fluid is installed prior to the initial heat up process. The excess cooler fluid may then be wiped away, leaving the colder moisture laden fluid to occupy the desired areas.

The chilled and moisture controlled fluid may be used for electrostatic attraction enhancement upon the entire surface to be powder painted. Using the six panel door as an example again, the cooler fluid can be retained on the entire surface. A temporary edge can be installed around the perimeter of the door that serves to contain the heavier chilled and moisture controlled fluid. The chilled fluid is installed in the same manner as explained above, except that it will occupy the entire surface to be powder coated. The retaining edge that contains the chilled fluid may be a part of the holding fixture that is attached to the conveyor, a discard or recyclable device, or an integral part of the object to be powder coated.

Warmer moisture controlled fluid may also be used to enhance the electrostatically charged surface, but in a reversed scenario. It may be desirable to apply the powder coating to the underside of a particular part. In this situation, the warmer moisture controlled fluid will now rise and occupy the aforementioned grooves. A similar retaining barrier can be placed about the perimeter to contain the warmer fluid from spilling upward and off of the subject part. This warmer fluid may be ionized air, possess a positive or negative charge, and be humidity controlled, or any combination of these conditions. An agent, typically gaseous, may be added to this fluid as an electrolyte in order to modify its electrical resistance relative to the ambient processing atmosphere.

It is an objective of the invention to utilize the inherently low thermal conductivity of the substrate in the formulation of the process and subsequent processing apparatus design. After the possible application of moisture controlled cool (or warm) fluid, the substrate is then subjected to high levels of infrared radiation that will rapidly heat the surface, regardless of thickness, to uniform temperatures. This is true because the absorption ability of IR radiation by the wood surface is high, but its thermal conductivity is considered to be very low. The surfaces of thin and thick areas can be quickly and uniformly raised to elevated temperatures, such as 225° F., without dramatically affecting the temperature of the substrate only fractions of an inch below the surface. If adjacent thick and thin areas measure 1.0″ and 0.1875″ respectively, both surfaces can be brought to the previously mentioned temperature of 2250° F. quickly, for example, in six seconds of process time. Since the thermal conductivity of the substrate is low, relative to other materials that are commonly powder coated, the surface temperature energy will not quickly dissipate by thermal conduction into the depths of the substrate. Due to the advantageously low rate of thermal conductivity, the substrate will achieve uniform temperatures on the IR processed surfaces, regardless of thickness. However, this condition of uniformity will not remain for long periods of time, especially when the substrate must travel a significant distance through space and time to the powder spray application.

It should be noted that the atmosphere, including the chilled (or warm) moisture controlled fluid, does not efficiently absorb IR radiation. The cool (or warm) fluid that contains the valuable moisture for enhancing the electromagnetic attraction of the powder is not in jeopardy when applied prior to the initial IR preheat process. The IR radiation will pass freely through the cool (or warm) fluid that is lying in the grooved areas, and will be successfully absorbed by the substrate. Some heat transfer may occur from the substrate to the enhanced fluid, but primarily by thermal conduction. The heat energy transfer will be proportional to the temperatures achieved in the substrate, the temperature of the enhanced fluid, the relative humidity of the chilled (or warm) air, and the amount of time of intimate contact prior to the application of the powder coating. This invention calls for a minimum of time between radiation processing and the application of the powder, and in some cases, may be simultaneous. The IR radiation process does not endanger the strategic value of the supplemental enhanced fluid. The moisture controlled fluid will still be retained in the grooves after preheating and upon presentation of the substrate to the powder cloud. The temperature controlled fluid will also act as a governor for the maximum temperatures achieved in the thinner substrates, depending on its actual temperature and moisture content. It should also be noted that the controlled fluid may offer less electrical resistance than the atmosphere in the surrounding work environment and may be a more favorable electrical conductor for accommodating the electrostatic powder coating process.

Thermal conductivity within the substrate is not the only reason for temperature anomalies on the process surface. Radiant losses from the heated surface typically exceed convective losses at elevated temperatures, such as 225° F. The emissivity of the wood surface is inherently high, causing the heated part to efficiently emit its thermal energy into space in the form of infrared radiation. This radiant energy loss rapidly decreases the surface temperature of the interface area of the wooden part in process. Lengthy travel time to separate processing equipment allows for a rapid decline of surface temperature because of the combination of radiant, convective and conductive losses. Current processing practices have frequently provided for extended soak times in hot convection ovens in order to satisfy heat sink areas. This can create greater temperature anomalies if the travel time to the next process is lengthy. The thin areas will lose their heat faster because there is less stored energy present due to reduced mass. The rate of thermal losses from the surface of thick and thin areas is equal, but the thin areas attain lower temperatures faster because there is simply less stored energy contained in these less massive areas. Greater temperature differentials between thick and thin parts can then result, causing a chain reaction of events that negatively affect the powder process.

An objective of this invention is to take advantage of the low rate of thermal conductivity that is inherent to the natural physical properties of the wood material by heating its process surface to uniform temperatures moments prior to the application of the powder coating. Maximum temperature uniformity exists before the heat energy has had time to conduct into the depths of the substrate or to be lost by radiant (and convective) means. This invention permits the highest level of surface temperature uniformity to exist, regardless of thickness, by eliminating unnecessary travel time through inadequately controlled equipment areas during the process. The resulting temperature uniformity preserves the natural and artificial moisture layers that facilitate high electrostatic attraction. The invention also produces ideal surface temperatures, without exceeding the target temperature value, during the application of the powder, which assists in the successful attachment of the powder to the interface area of the substrate.

An objective of this invention is to maintain the substrate surface temperature during its travel through time and space between the preheating oven to the actual application of the powder coating upon said surfaces. The preheating oven is often a convection oven, but may be a radiant oven, microwave, or combination of convection and radiant heating methods.

The invention will permit the maintenance of the surface temperature of the substrate, to a high degree, after it has exited the preheat oven (often convection), but before it has been powder coated. This can permit the reduction of the higher substrate preheating temperatures that had been intended to compensate for the thermal degradation experienced during the travel between the preheat oven and the powder spray application equipment. The area between the preheat oven process and the powder spray application equipment is often designated as a hazardous area, and does not possess the atmospheric thermal properties or processing equipment that is required to maintain the surface temperature of the substrate. The ability to lower the preheat oven processing temperature to that of the actual target temperature will reduce the problems associated with the higher compensatory thermal set point. This temperature reduction is highly dependent upon the ability to maintain the preheated surface temperature during the transition through the unheated equipment area, which is an objective of this invention.

An objective of this invention is to achieve the maximum allowable thermal expansion differential between the surface of the wooden substrate and the balance of its mass during the powder coating process. It has been observed that some types of wood products incur damage from thermal expansion, such as cracking or splitting of the substrate, when attempting to achieve high surface temperatures relative to the inner substrate temperature. The thermal expansion factor varies, and is dependent upon the nature of the wood or wood composite product. If a particular wood product possesses a high thermal expansion factor, then its physical size will increase, relative to its temperature, to a greater extent than another wood product of a lower thermal expansion rating. As previously explained, the majority of the wood products have a very low thermal conductivity rating coupled with high absorption ability of infrared radiation. These characteristics cause the wood product to experience a large surface temperature increase in a small period of time when exposed to only modest power levels of infrared radiation. If the particular wood product also has a high thermal expansion factor, then its outer surface will attempt to increase in size in large proportions relative to the virtually unheated areas that reside only fractions of an inch below the heated surface. This differential of thermal expansion between the surface and inner mass of the wood product has maximum limits that may occur without physical damage or otherwise negative process results for any one particular type of wood product.

The processing of wood products at the maximum allowable thermal expansion differentials that do not cause structural damage within the part will provide the greatest processing efficiency. However, some have chosen to preheat the wood product at a low rate of temperature rise over long periods of time to prevent damage from thermal expansion. This method is inefficient because the rate of temperature rise, and the resulting thermal expansion differential, is well below the maximum allowable limit. The artificially high set point temperature that is used to compensate for the aforementioned surface temperature drop during conveyor travel also complicates the thermal expansion aspect in this process.

The invention will allow for greater control in the heating of the wood substrate so that the part can be processed at or near the maximum allowable thermal expansion differential. This will achieve the greatest efficiency in the use of process energy, reduce equipment size, and minimize the required plant manufacturing floor space.

The thermal expansion differentials can be managed by applying strategic thermal gradients within the wooden substrate in process. This involves the heating of the substrate to successively higher temperatures in steps of predetermined time. The differentials of expansion will be proportional to the thermal gradient created within the part, resulting in a reduction in the expansion differentials as measured incrementally within the part in process. The expansion differential is then spread over a larger distance of space and time. Radical changes in temperature and expansion between the surface and the underlying material are then reduced. A higher ratio of expansion differentials is preferred to a low ratio within a wooden substrate. A graphical representation of this concept, where the X axis represents equal increments of distance as measured from the inside to the outside surface, and the Y axis represents the amount of expansion, would result in an upward slope. This is in contrast to the graphical representation of unacceptable thermal expansion differentials that would appear as a sudden change of expansion within a relatively small distance. The invention provides the ability to carefully control and strategically shape the thermal gradient and thermal expansion differentials to avoid substrate damage and to maximize processing efficiencies.

An objective of this invention is to successfully integrate pre and post process heating equipment, radiation processing equipment, liquid and/or powder spray equipment, and the spray booth into one common device. The above advantages can then be gained in the advancement of powder coatings on non-conductive substrates, such as wood. Current regulations prohibit the installation of certain heat and/or radiation processing equipment within the spray booth area.

An objective of the invention is to remotely transfer electromagnetic radiation (IR/UV) in adequate density to the part in process with high transfer efficiency while maintaining a minimum safe distance from the spray booth enclosure. This is accomplished by remotely mounting the radiation emitting devices from the hazardous environment and channeling the radiation through a Wave Guide and Correction Lens (WGCL) system.

There is a general misunderstanding of the nature of electromagnetic radiation in industry today. A misconception exists that all infrared or ultraviolet radiation loses power if sent over long distances. This is not true, but only appears to be true. The energy is not lost, and will travel virtually forever until it is absorbed by a surface. However, the energy does tend to disperse at angles that dissipate its concentration, creating the illusion that the rays simply disappeared because of distance. If the radiation is prevented from scattering in multiple directions, as with highly aligned laser emissions, the energy can travel for astronomical distances without experiencing reductions in power density. Therefore, a mission objective of this invention of transferring the highly concentrated radiation for a distance of about 10 to 20 feet into a normally hazardous area is attainable.

The wave guide is a tubular device that channels electromagnetic radiation from a remote location to the work in process while limiting the dispersion of the total radiant energy emission, thereby maintaining the vast majority of its power density per square area of measurement upon delivery to its destination. The radiant energy is guided and corrected (where necessary) to prevent it from expanding over a larger area during its travel through time and space. Strong correction of radiation that is not in the desired alignment occurs within the correction lens. Hence the names of Wave Guide and Correction Lens for this aspect of the invention. The WGCL assembly may be round, square, rectangular, elliptical, or any reasonable shape from an end view. It may also be straight or curved from the side view, although a straight configuration minimizes losses from internal surface absorption.

The WGCL compensates for the natural tendency of electromagnetic energy to radiate omni-directionally, thereby facilitating an efficient and long distance transfer of concentrated electromagnetic energy to the desired target object while maintaining high watt densities. The WGCL may contain multiple channels and separately controllable emitter devices in order to provide precise yet long distance multi-zone emission control of said electromagnetic energy. The WGCL may also be comprised of multiple correction lenses inside of a larger wave guide to assist in the alignment of said radiation prior to its long distance transmission.

The WGCL is capable of serving a dual purpose. The WGCL can act as a duct for the flow of fluids simultaneously to the efficient delivery of electromagnetic radiation. Specifically, the overall invention herein provides for the WGCL to be purged with low velocity air in order to prevent particulate matter, namely powder coating material, from drifting into the device. The purging air shall be filtered, and may be conditioned for temperature, moisture content, ionization, or other process variables that apply to supply fluids in spray booth environments, as well as the inclusion of gaseous electrolytes that reduce the electrical resistance of the purging air.

The WGCL may include strategically placed damper doors to act as a valve to an undesirable reverse flow of purging air. This reverse flow prevention valve can be held open during normal operation, and will naturally close upon failure of the valve damper solenoid. This is considered to be in conformance with fail-safe safety regulations.

The WGCL may include the attachment to fire protection equipment, which may include water deluge, carbon dioxide, halon, or other fire protection substances that are intended to smother any fires that may occur. The WGCL will naturally channel the fire fighting substance directly to the parts in process.

The WGCL will not physically attain objectionable surface temperatures at the point of delivery of the concentrated electromagnetic radiation to the part in process. Low temperatures of the WGCL are maintained because the source of the process radiation has been pre-aligned to minimize radiation contact with the WGCL by using a scientific reflector system. Most of the radiation will travel in a near parallel position relative to the internal walls of the WGCL device. However, the actual emitter source occupies more than a theoretical point in space, possessing three dimensional characteristics. This means that some of the radiation will not be perfectly aligned in its delivery from a parabolic or elliptical reflector system into the WGCL. The WGCL guides and realigns this imperfectly directed off-axis radiation during the transmission process. The WGCL will not efficiently absorb the radiation because its internal walls are highly reflective to the subject radiation. Further, the small quantity of radiation that strikes the internal surfaces of the WGCL are at low angles of incidence that are not favorable for efficient absorption; generally less than a 10° angle of incidence. The purging air and a relatively large physical surface area also tends to stabilize the surface temperature of the WGCL at low thermal values, generally less than 120° F.

The IR and UV radiation emitters are separately cooled with low volume air, generally 5 CFM per emitter. These thermal losses (waste heat) can be removed from the emitter devices and kept separate from the WGCL purging air. This also reduces undesirable temperature buildup in the WGCL. The preferred emitter devices are protected under existing and pending patents. However, the WGCL can utilize other emitter devices, such as gas radiant burners (catalytic or direct combustion type). UV emitters may be of the conductive gas type, resistance type, fluorescent type, etc.

Multiple WGCL devices can be positioned through the ceiling and/or walls of the typical powder spray booth. The radiation emitter fixture devices are positioned at the outside end of the WGCL devices. The electrical and/or gas electromagnetic emitter equipment will be located at a safe distance from the hazardous area. Therefore, the WGCL will extend at least five feet beyond the furthest boundary on the outside of the spray booth equipment. The process emission delivery end of the WGCL can be located in very close proximity to the work in process. The WGCL may be located in close proximity to the spray application equipment, but the process radiation will be primarily directed to the target that is adjacent to the powder application equipment. This will enable the objectives of heating the target interface area to the desired temperatures only moments before, during, and/or after the application of the powder. All hazardous equipment is located at the safe and legal distance of at least five (5) feet as currently specified by NEMA and NFPA equipment safety regulations. All equipment surface temperatures will be acceptably low as required within the restricted areas.

An objective of the invention is to greatly reduce and possibly eliminate the buildup of powder coating material on the emitters of radiation, emitter connectors, emitter reflector systems, and general radiation processing equipment. Powder material has migrated into adjacent equipment that is located beyond the prescribed distance that is imposed by law. This occurs over long periods of time, and has presented some major problems with the efficient maintenance of the processing equipment. Safety issues have also occurred that are not recognized by safety laws. The invention reduces this problem and may eliminate the deposition of powder material on these components.

Another objective of the invention is to comply with safety regulations that apply to hazardous areas, such as spray booths for coatings. The invention permits such safety while providing the advantages of specific infrared and ultraviolet radiation processing in close proximity to the spray application.

### SUMMARY OF THE INVENTION

The present invention relates to an apparatus and method for increasing the efficiency of processing paint coatings on wood, wood-based and plastic substrates and provides for a multi-step process to control certain process variables. A method and apparatus are provided by the invention to maintain the surface temperature of the wood-based or plastic object in process (assuming parts are preheated) and to increase the surface temperature of said objects within the paint spray booth area in a safe manner. The present invention safely combines the spray booth equipment with process radiation and heating equipment to achieve increased efficiency and enhanced control of process variables.

The parts to be coated may be delivered in a flat position or hanging from a conveyor. Movement may be indexing or continuous flow. The conveyor may be from overhead or floor mounted. Detector devices, such as a beta scanner or other existing automatic moisture detecting device, shall determine the moisture content in the substrate. This moisture detection shall include known problem areas, such as significantly thinner substrate areas. The need for supplementing the moisture content of the substrate with controlled fluid will be determined from this data by a programmable controller that operates the system. If the substrate could benefit by the addition of moisture laden fluid to enhance the electrical conductivity of the surface of the substrate, the controlled fluid shall be installed upon the part. The controlled fluid may include modification of the content of water or water vapor, contain a positive of negative electrostatic charge, contain no ionization, vary in temperature, or a reasonable combination of these variables. The fluid shall be variable in velocity and shall be contained by a valve to prevent fluid flow if so desired. The fluid shall be highly filtered to remove undesirable particulate matter. The use of this fluid (often conditioned air) may not be required in all cases.

In certain equipment designs and processes, the substrate has been preheated with a convection oven, or by other means, and the application of infrared radiation is intended to maintain the temperatures achieved in that particular processing equipment. In that event, the infrared radiation would be applied immediately, or nearly so, upon the substrate exiting the preheating equipment. The infrared radiation will then be continually applied, or nearly so, during the conveyance of the substrate from the preheating oven to the area in which the powder coating is actually applied.

The infrared radiation can be introduced immediately following the application of controlled fluid to pre-heat the surface or surfaces to be processed with the powder coating. The infrared radiation used for the particular substrate may vary in peak wavelength and watt density. A peak wavelength range for this process may vary from 0.76 microns to 10 microns in length. The infrared shall rapidly heat the surface immediately prior, and in some cases simultaneously, to the application of the powder coating material. The IR radiant processing equipment will reside at safe distances as specified by national safety regulations. The value of the controlled preheating of the substrate immediately prior to applying the powder coating has been described above.

Post-heat application of IR radiation can also occur simultaneously to the powder application, or quickly thereafter, to achieve coalescing, flow out of the liquefied powder coating, and general preparation for UV processing (if required).

The powder is applied with electrostatic spray equipment. Current technology provides for the tribo or corona discharge electrostatic spray methods. However, it is possible to utilize a non-charged method of application where adequate and even heating prior to the application of the powder will cause the material to melt on contact. Although electrostatic methods of application assist in uniformity of powder film build, it may not always be necessary in certain application.

The latter method can be compared to the fluidized bed method of coating objects with a powder coating. However, this method calls for a concentration of powder material at reduced density of powder particles. The fluid that keeps the powder in suspension must be adequately free of humidity and can be pre-heated to reduce the temperature differentials the between the powder particle temperature and the pre-heated object to be powder coated.

The powder is commonly delivered to the gun via an air stream. This air stream can be heated air. It can be heated to the highest possible temperature that will not damage the powder coating material, which temperature is dependent upon the formulation of the particular power product. It is desirable to reclaim the powder that is not damaged or placed upon the substrate. This temperature can range from 60° F. to 400° F. Certain UV curable powder may benefit from preheated delivery air of about 120° F., which would reduce the Delta T by about 50° F. in most cases. The purpose of heating the delivery air is to reduce the Delta T between the powder and the heated substrate. The lower the Delta T, the lesser the post-heat energy requirement, and the shorter the time requirement for the powder to coalesce.

After application of the powder onto its substrate, it is desirable to heat the powder to aid in its melting and flow out. Flow out provides for similarities in viscosity and permits the coating to assume a uniform appearance. The post-heating operation is performed with infrared radiation that is delivered with the WGCL, assuming that this device is required to maintain safe conditions as imposed by NEMA and NFPA safety regulations.

Other radiant heat processing equipment can be used if placed at safe distances from the invention. However, it has been observed that powder coating materials tend to migrate through the air over time, causing unwanted deposits in normally safe areas. These deposits tend to accumulate to substantially thick proportions that hamper the maintenance of other radiant processing equipment. For areas such as this, the invention includes radiant processing equipment that prevents the intrusion of powder particles into its housings and from coming into contact with the radiant emitter source. This applies specifically to infrared and ultraviolet emitter equipment, but may apply to any electromagnetic emitting equipment.

After the flow out of the liquefied powder has been achieved, but before the application of the UV radiation that facilitates cross-linking, it may be desirable to modify the appearance of the powder coating surface. In some cases, it is desirable to create a wrinkled finish, matte finish, or otherwise, non-glossy finish. When the liquefied powder coating has flowed out, extremely cold and controlled gas (such as air) can be applied to the hot coating. This will cause a sudden contraction or shrinkage of the liquefied surface, while liquefied powder coating of substantially higher temperature resides below the surface. When the wrinkled appearance is achieved, the UV radiation can be suddenly applied, causing the entire coating to quickly cure in the wrinkled and distorted state.

If other appearance patterns are desired, and the coating is of adequate thickness, an appearance modification can be achieved through physical contact with a chilled surface. The highly cooled and uncured coating can be physically manipulated with imprinting rollers, then suddenly cured by applying the UV radiation. The sudden cure will permanently preserve the appearance since elevating their temperatures cannot soften thermosetting materials. The chilled fluid used for appearance modifications can be controlled with respect to relative humidity levels, static charge, temperature, and may contain a variety of gaseous materials. Additional infrared radiation may be applied after the cooling fluid and/or ultraviolet radiation.

The invention provides compact and efficient processing that also allows for multiple coatings to be applied in close physical proximity. After the initial deposition and flow out of the first coat of powder material, additional powder applications will adhere to the hot liquefied powder, either before, simultaneously, or after cross-linking with UV. Therefore, significant film build can occur in each successive application while applying the ultraviolet and/or infrared and/or any process radiation immediately adjacent to each electrostatic powder cloud, if not simultaneously applied.

In some cases, it may be advantageous to cross-link the coating with UV radiation between coats, but also maintain higher surface temperatures. This causes successive powder coatings to coalesce upon contact with the prior coat, causing the freshly applied powder to bond to its interface area.

### BRIEF DESCRIPTION OF THE DRAWINGS

The various advantages of the present invention will become apparent to one skilled in the art by reading the following specification and subjoined claims and by referencing the following drawings in which:

FIG. 1 is a side view of a wave guide and correction lens assembly arranged in accordance with the principles of the present invention.

FIG. 2 is a cross-sectional end view of a fluid purged fixture taken along line A-A as shown in FIG. 3.

FIG. 3 is a front view of a fluid purged fixture.

FIG. 4 is a side view of a fluid purged fixture.

FIG. 5 is a cross-sectional side view detail of the fluid purged electrical connector as referenced in FIG. 4.

FIG. 6 is a side view of a powder processing system variation.

FIG. 7 is a side view of a powder processing system variation.

FIG. 8 is a side view of a powder processing system variation.

FIG. 9 is a plan view of a powder processing system variation.

FIG. 10 is a plan view of a powder processing system variation.

FIG. 11 is a cross-sectional view of an explosion-proof and fluid cooled electromagnetic emitter device taken along line B-B as shown in FIG. 12.

FIG. 12 is a side view of an explosion-proof and fluid cooled electromagnetic emitter device.

FIG. 13 is an end view of an explosion-proof and fluid cooled electromagnetic emitter device.

FIG. 14 is a cut-away end view of a fluid purged and fluid cooled emitter fixture.

FIG. 15 illustrate side and front views of ceiling mounted electromagnetic radiation WGCL with angled emission delivery and expanded radiant energy pattern of 1:25.

FIG. 16 is a front view detail of a telescopic wave guide power mechanical device.

FIG. 17 is a front view of four ceiling mounted electromagnetic radiation wave guides with angled emission delivery and expanded radiant energy pattern of 1:25, forming a 5 ft.×20 ft. wall of radiant energy.

FIG. 18 is a plan view of the four ceiling mounted electromagnetic radiation wave guides with angled emission delivery and expanded radiant energy pattern of 1:25 from FIG. 17, shown with the electrostatic powder spray equipment, also in plan view.

FIG. 19 illustrates a side view of a ceiling mounted telescopic wave guide shown in finished and usable form with telescoping outer protective covering. A wave guide device is also shown that is fully retracted into the ceiling.

FIG. 20 illustrates a side view and front view of wave guide devices with externally mounted fixtures and modified purging fluid flow with 1:25 expanded radiant energy factor.

FIG. 21 is a plan view of a powder processing system variation with transparent glass enclosure walls.

### DETAILED DESCRIPTION OF INVENTION

The invention is a combination of a paint spray booth, the application of conditioned fluid, paint spraying equipment, and radiation processing equipment. Specific components of the invention shall be illustrated separately in order to explain each apparatus that contributes to the satisfaction of the objectives of the invention. The overall invention shall also be illustrated that shows the combination of the separate components.

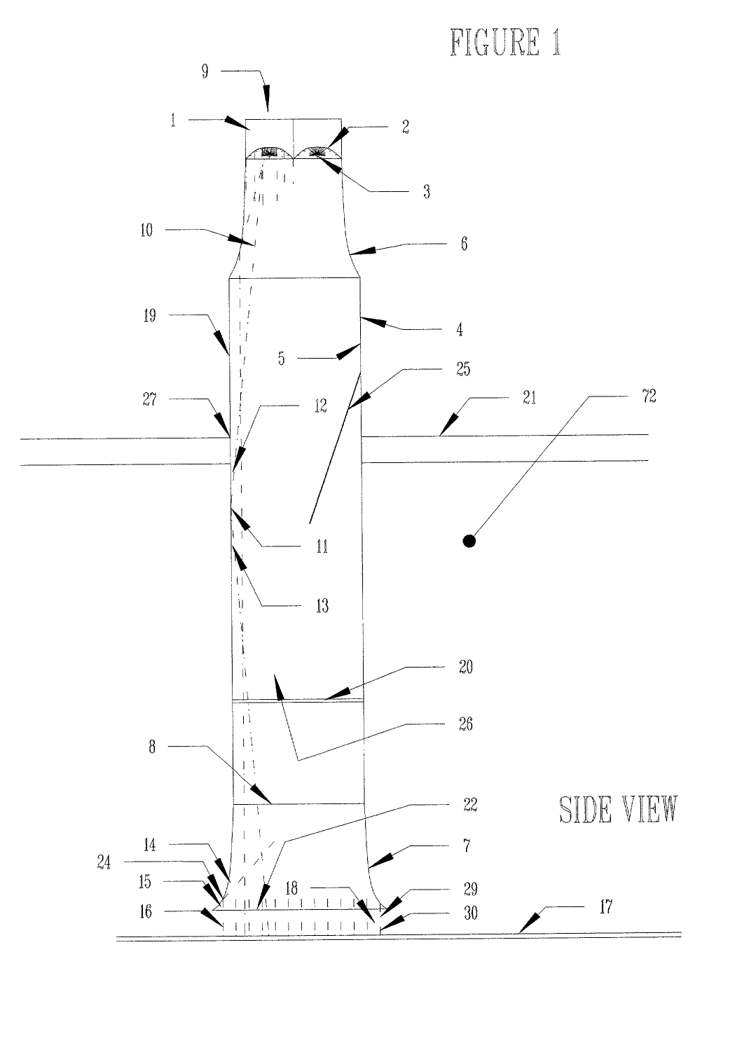

FIG. No. 1 is an illustration of a wave guide and correction lens assembly. An electromagnetic emitter fixture assembly 1 containing a directional electromagnetic emitter device 3 and a reflector system 2 is positioned at the entrance to the wave guide body 4. The reflector system 2 may be parabolic, elliptical, or other design type, and is intended to direct the electromagnetic radiation 10 into the wave guide body 4. The preferred electromagnetic radiation 10 will be infrared radiation 30 and/or ultraviolet radiation 29. It is preferred that the radiant emission 10 is aligned by the reflector system 2 that resides inside of the fixture assembly 1 and will be largely parallel to the internal reflective surfaces 5 inside of the wave guide body 4. The radiant emission 10 is corrected with the primary corrective lens 6 prior to traveling through the wave guide body 4. Low velocity air 9 may be passed through the fluid purged emitter fixture 1, and inserted directly into the wave guide body 4. The low velocity air 9 maintains a positive pressure inside of the wave guide body 4 and prevents the intrusion of airborne powder coating particles from entering through the delivery end 22 of the assembly. Radiation 10 that is not properly aligned will be guided at a reflection point 11 and will strike at this point 11 with a low angle of incidence 12. The angle of reflection 13 when striking the reflection contact point 11 will be approximately equal to the angle of incidence 12. This correction to the electromagnetic radiation 10 will confine the radiation and guide it toward its intended target surface 17. When some of the radiation 10 remains improperly aligned, the secondary alignment correction lens 7 will correct its angle. Radiation 10 in need of corrective alignment from the secondary corrective lens 7 is illustrated where it strikes the reflective surface at a point 24 on the secondary corrective lens 7 at a low angle of incidence 14. The angle of reflection 15 of the radiation 10 is then considered to be properly aligned radiation 16. The secondary corrective lens 7 is fastened to the wave guide body 4 at the illustrated attachment area 8. The aligned radiation 16 can then strike the target surface 17 and possess adequate power density to perform the radiant processing task. The purging fluid 9 (often air) has traveled through the primary corrective lens 6, wave guide body 4, and secondary corrective lens 7 in order to escape as exhaust purge fluid 18 (often air). The wave guide body 4 may contain a flame arrestor 20 that is typically made of screen material. Flame will not pass through a screen flame arrestor 20, which adds to the safety of the invention and entire process. In the event of unwanted reverse air flow 26, where ambient air would enter through the secondary corrective lens 7 and into the wave guide body 4 and fluid purged emitter fixture assembly 1, a reverse airflow valve 25 will close (shown partly closed) to prevent the unwanted reverse airflow 26. This will prevent any powder particles from coming into contact with the fluid purged emitter fixture housing 1, reflector 2 and directional emitter devices 3. The entire wave guide correction lens system FIG. 1 is intended to pass through a partition surface 21 of the spray booth system where a seal 27 maintains a separation between the spray booth area 72 and the atmosphere outside of the spray booth area 72. The potentially hazardous fluid purged emitter fixture 1 is kept at a safe distance from the outer surface of the spray booth partition 21 as currently prescribed by law. Piping for fire protection can be connected at any convenient point 19 that does not interfere with the intended operation of the wave guide body 4. The fluid purged emitter fixture 1 may utilize gas, electricity, or other energy source to generate the electromagnetic radiant energy 10 that is ultimately intended to be transferred to the target surface 17 in the form of aligned radiation 16 for the purpose of strategically processing the target surface 17. The electromagnetic radiation 10 may be of any wavelength classification of electromagnetic radiation, such as infrared 30, ultraviolet 29, light, microwave, radar, electron beam, radio, or any combination of any wavelength classification of electromagnetic radiation. The partition surface 21 of said spray booth area 72 may be defined as any partition commonly referred to as a wall, roof, floor, silhouette, filter medium, or any surface that separates the spray operation and its ambient atmosphere from any other area in which the invention is located.

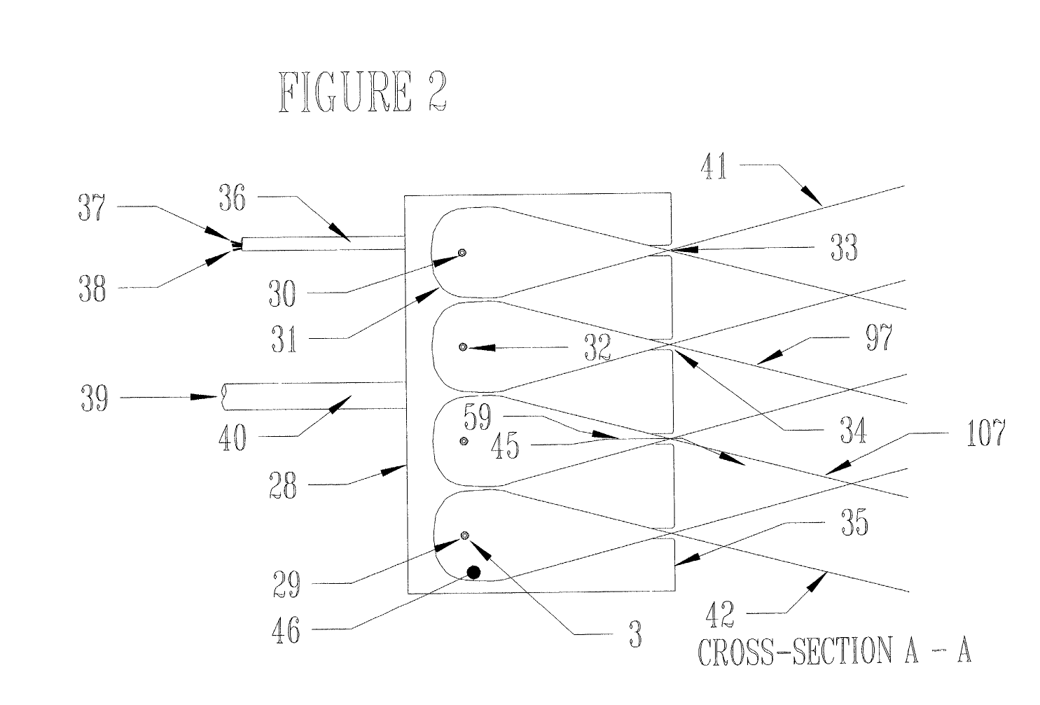

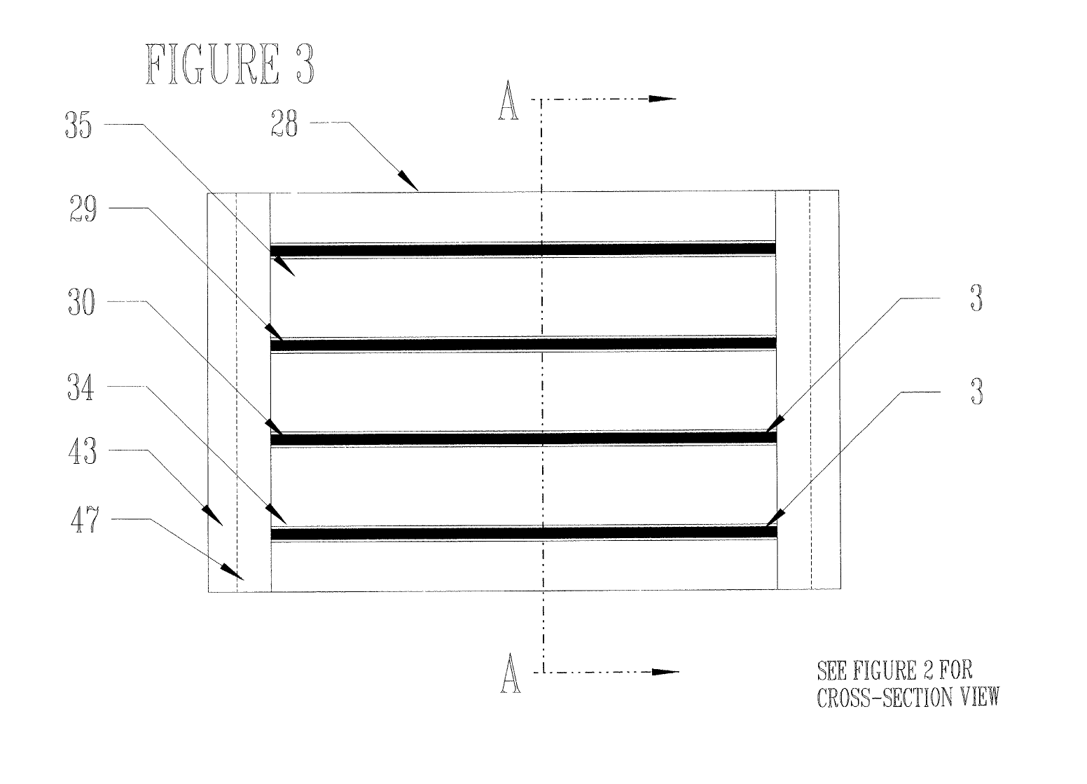

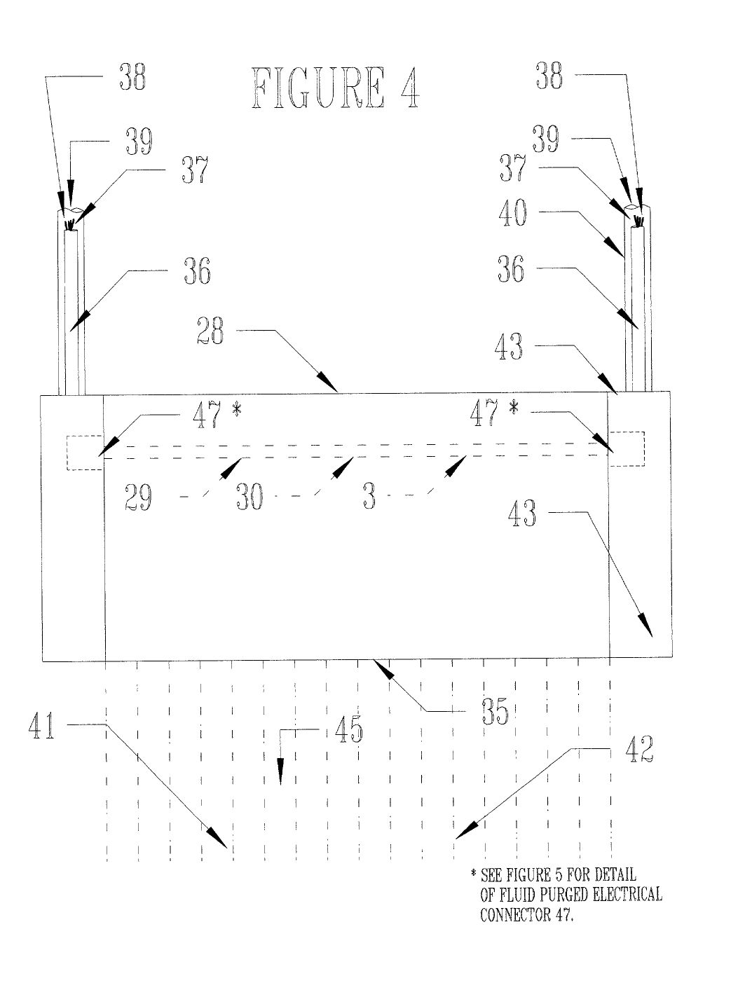

FIG. 2 illustrates a fluid purged fixture for containing, supporting, cooling, protecting and electrifying electromagnetic radiation emitter devices in explosive areas containing gases and high concentrations of airborne particulate matter, such as powder coating particles. The invention consists of fixture housing 28 constructed of a noncombustible material of high structural strength, such as metal or metal alloy. The fixture housing 28 contains a reflector system 31 that is capable of focusing electromagnetic energy, specifically infrared radiation (IR) 41 and ultraviolet radiation (UV) 42, or any other form of electromagnetic energy 97, including light 107. The IR emitter 30 or UV emitter 29 is located at the primary focal point 32 of the reflector system 31. The IR radiation 41 or UV radiation 42 is highly focused to a secondary focal point 33. The IR radiation 41 or UV radiation 42 then experiences an image reversal beyond the secondary focal point 33 where it crosses over and expands over a larger area as it passes through a fluid purged slot 34. The fixture housing 28 is purged by forcing the purging supply fluid 39 (often air) into the fluid supply piping 40. Turning to FIG. 3 and FIG. 4, the purging supply fluid 39 is uniformly distributed through each of the two fluid manifold/electrical housings 43 and into each fluid purged electrical connector 47. In FIG. 2, the purging fluid 39 is uniformly inserted into each reflector chamber 46 in order to provide a positive pressure relative to the ambient atmosphere in which the invention is located. The hot fluid exhaust 59 from the emitters 29 and 30 is combined with the supply fluid 39 within the reflector chamber 46. The pressurized supply fluid 39 and hot fluid exhaust 59 in each reflector chamber 46 then passes through a plurality of fluid purge slot 34 as fluid purge exhaust 45. Electrical power is distributed to the IR emitters 30 and the UV emitters 29 through the IR electrical wiring 37 and the UV electrical wiring 38, which is contained by airtight electrical conduit 36. The IR emissions 41 and/or UV emissions 42 emerge from the fluid purged slots 34 in conjunction with the fluid purging exhaust 45. The fluid purging exhaust 45 escapes through the fluid purged slots 34 at increased velocity relative to the pressurized purging fluid 39 within the reflector chambers 46. The high velocity fluid purging exhaust 45 prevents the intrusion of potentially explosive airborne particulate matter and gasses into the fixture housing 28 and reflector chambers 46. Turning to FIG. 3, the front view illustrates a reflective exterior face 35 that is highly reflective of the IR emissions 41 and/or UV emissions 42 that pass through the fluid purged slots 34. Also shown in FIG. 3 is a plurality of IR emitters 30 and UV emitters 29 that can be observed through the fluid purged slots 34. FIG. 4 illustrates the simultaneous dispersion of IR radiation 41, UV radiation 42, and fluid purging exhaust 45. The exterior of the fixture housing 28 and reflective exterior face 35 remain at reasonable temperatures during normal operation that are acceptable to safety standards for the NEMA rated area in which the equipment resides.

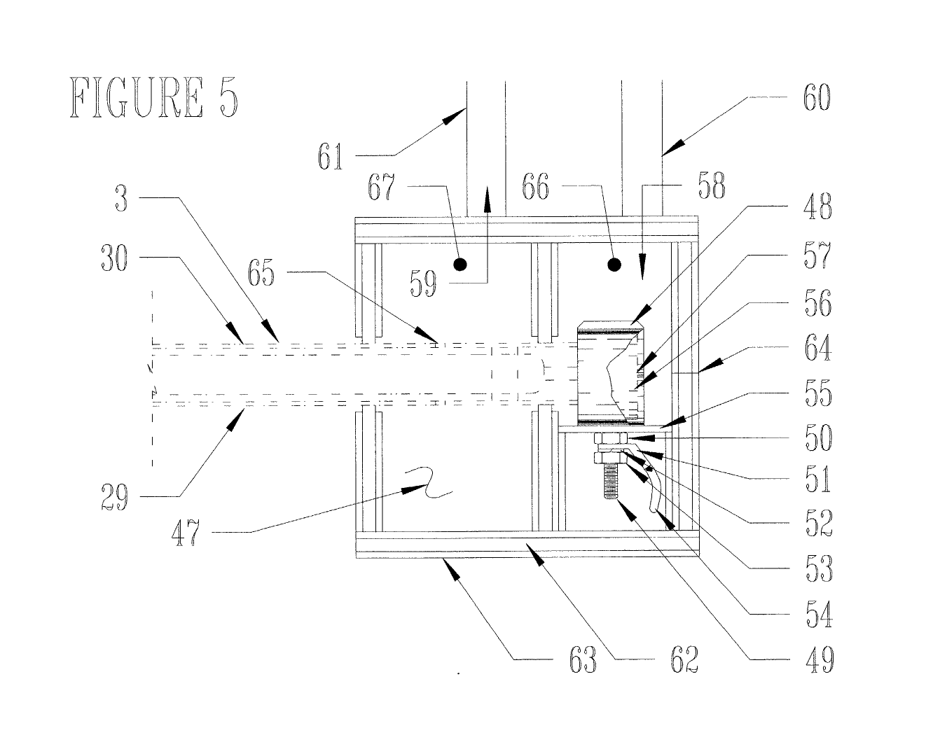

Moving to FIG. 5, a fluid purged electrical connector 47 is illustrated in detail. The fluid purged electrical connector 47 is constructed from a high temperature metal housing 63 that contains insulation 62 to reduce thermal conductivity. The fluid purged electrical connector 47 can open in a clamshell fashion at a hinge joint 64. The pressurized supply fluid chamber 66 and the pressurized exhaust fluid chamber 67 are two separate chambers within the fluid purged electrical connector 47. The pressurized supply fluid chamber 66 houses an electrical clip 48 that electrifies and mechanically supports an infrared emitter 30 or an ultraviolet emitter 29. The electrical clip 48 is attached with a threaded stud 49 that protrudes through an electrically non-conductive terminal support 55 and is fastened with a fastener nut 50. Electrical power is connected to the threaded stud 49 through an electrical power wire 54 and ring tongue terminal 51. The ring tongue terminal 51 engages the threaded stud 49 and is held in position by a ring tongue terminal nut 53 and a lock washer 52. Stainless steel end caps 56 reside on each end of said emitters 30 and 29, which snap into the electrical clip 48 for electrification and mechanical support. Pressurized cooling fluid 58 is introduced into and through the pressurized supply fluid chamber 66 through the fluid supply tube 60. The pressurized cooling fluid 58 then enters the infrared emitter 30 or ultraviolet emitter 29 through an inlet orifice 57 in the stainless steel cap 56. The pressurized cooling fluid 58 passes into and through the interior of the infrared emitter 30 or ultraviolet emitter 29 to cool the said emitter devices. The pressurized cooling fluid 58 then exits an exhaust orifice 65 within the infrared emitter 30 or ultraviolet emitter 29 as pressurized hot exhaust fluid 59 and enters the pressurized exhaust fluid chamber 67. The hot exhaust fluid 59 then exits the pressurized exhaust fluid chamber 67 through the exhaust fluid tube 61, thereby removing undesirable heat from the infrared emitter 30 or ultraviolet emitter device 29. Reverting to FIG. 2, the hot exhaust fluid 59 may be introduced into a reflector chamber 46 and mix with the fixture purging fluid 45, thereby exiting said reflector chamber 46 through the corresponding fluid purged slot 34. Turning back to FIG. 5, the hot exhaust fluid 59 can be channeled away through the exhaust fluid tube 61 in order to keep the hot exhaust fluid 59 from entering the atmosphere within the processing environment.

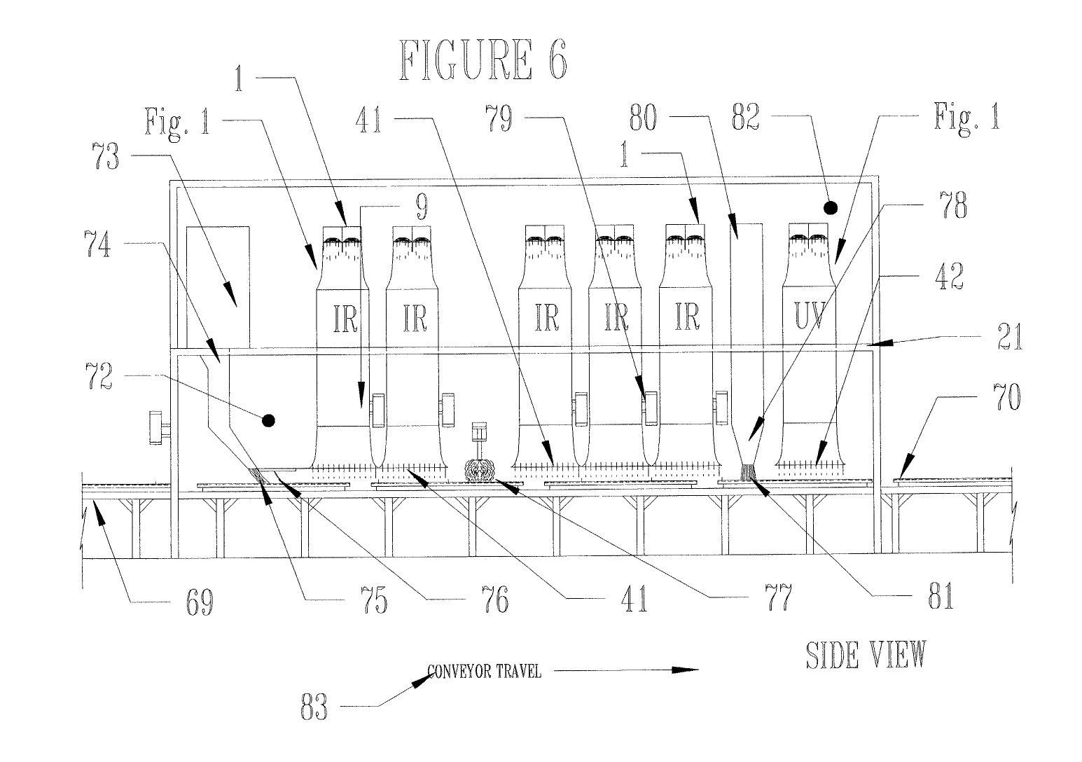

FIG. 6 is an illustration of the invention, and is a processing system variation. FIG. 6 features flatline processing for the horizontal processing of flat products 70 that are indexed or continuously conveyed in the conveyor direction 83 as shown upon a processing conveyor 69. FIG. 6 illustrations assume that the flat parts 70 in process may not have been preheated before entering the spray booth area 72. However, preheating of the flat part 70 is not precluded as part of the invention as illustrated in FIG. 6. Prior to entering the spray booth area 72, the moisture content of the flat parts 70 is determined by a reading from the moisture sensor scanner 71. This data is queued in a processing system programmable controller in order to make automatic processing decisions for the particular flat part 70 in process. The flat part 70 then enters the spray booth area 72 via the conveyor 69. If the flat part 70 needs supplemental moisturized chilled fluid 75 placed upon the surface of the part 70 to enhance the electrostatic attraction of the particles contained in the powder application cloud 77, the chilled and conditioned fluid 75 is dispensed from the fluid conditioning device 73 through the application nozzle 74 at a similar rate of velocity as that of the movement of the flat part 70. The chilled and conditioned fluid 75 will lay upon the flat part 70 due to its relatively high weight compared to the standard air that is present in the spray booth area 72. If it is desirable to have the chilled and conditioned fluid 75 occupy only recessed areas in the flat part 70, a spreader bar 76 will wipe off the chilled fluid 75, leaving a deposit of said fluid 75 in the recessed areas. The flat parts 70 are then conveyed under a WGCL assembly FIG. 1 for heat processing with infrared radiation 41 that has been generated and guided, in part, from an fluid purged fixture 1 as illustrated in FIG. 1. The infrared radiation 41 will effectively heat the surface of the flat part 70, while efficiently passing through the chilled conditioned fluid 75. This will largely preserve the moisture content in the chilled and conditioned fluid 75 to enhance the electrostatic attraction of the particles contained in the electrically charged powder cloud 77 while generating the desired surface temperatures upon the flat part 70. The flat part 70 then moves to the electrostatically charged powder cloud 77, where the powder coating is applied. The heated surface of the flat part 70 causes the powder particles in the electrostatically charged powder cloud 77 to begin to coalesce upon contact with the surface of the flat part 70. After application of the powder coating, the flat part 70 will continue to be heated with infrared radiation 41 to liquefy the powder and to facilitate its flow out and leveling. Surface temperatures of the flat part 70 are monitored both before and after the application of the powder coating through a plurality of infrared non-contact thermometers 79. The programmable controller also interprets feedback from the infrared thermometers 79 to automatically maintain or modify the surface temperatures of the flat parts 70 in process within adjustable parameters. It may be desirable to alter the appearance of the coating upon the surface of the flat part 70. In that event, frigid and conditioned fluid 81 may be dispensed from the frigid and conditioned fluid processing equipment 80 through a nozzle 78 and impinged upon the hot and liquefied coating upon the surface of the flat part 70. The frigid and conditioned fluid 81 will cause the liquefied powder coating to rapidly contract, causing a matte and/or crinkled surface appearance upon the coating upon the flat part 70 in process. As the flat part 70 continues along the conveyor 69, the surface of the coating is exposed to ultraviolet radiation 42 via another WGCL as previously featured in FIG. 1. The ultraviolet radiation 42 will react with a photoinitiator that may be present in the liquefied powder coating, acting as a catalyst to the rapid cure of the liquefied powder coating. The UV curing applies to UV curable powder coatings, and may not apply to thermally cured powder coatings. If surface appearance modifications are desired upon UV curable powder coatings, the rapid cure obtained from the exposure to the ultraviolet radiation 42 will permanently preserve the altered appearance achieved from processing with the frigid and conditioned fluid 81. Appearance changes may also occur upon the surface of thermally cured coatings, but it should be noted that a rapid cure of the powder coating may not occur from exposure to the ultraviolet radiation 42 if no photoinitiator is present within the powder coating chemical formulation.

In FIG. 6, the fluid purged emitter fixtures 1, as illustrated in detail in FIG. 1, are maintained at a safe distance (typically a minimum of five feet) from the spray booth area 72 and its outer extreme partition 21, permitting the safe execution of one or more of the objectives of the invention. The fluid purged fixtures 1 are shown within an air house area 82 that supplies highly filtered low velocity air 9 into the spray booth area 72 via the WGCL FIG. 1 as illustrated in detail in FIG. 1.

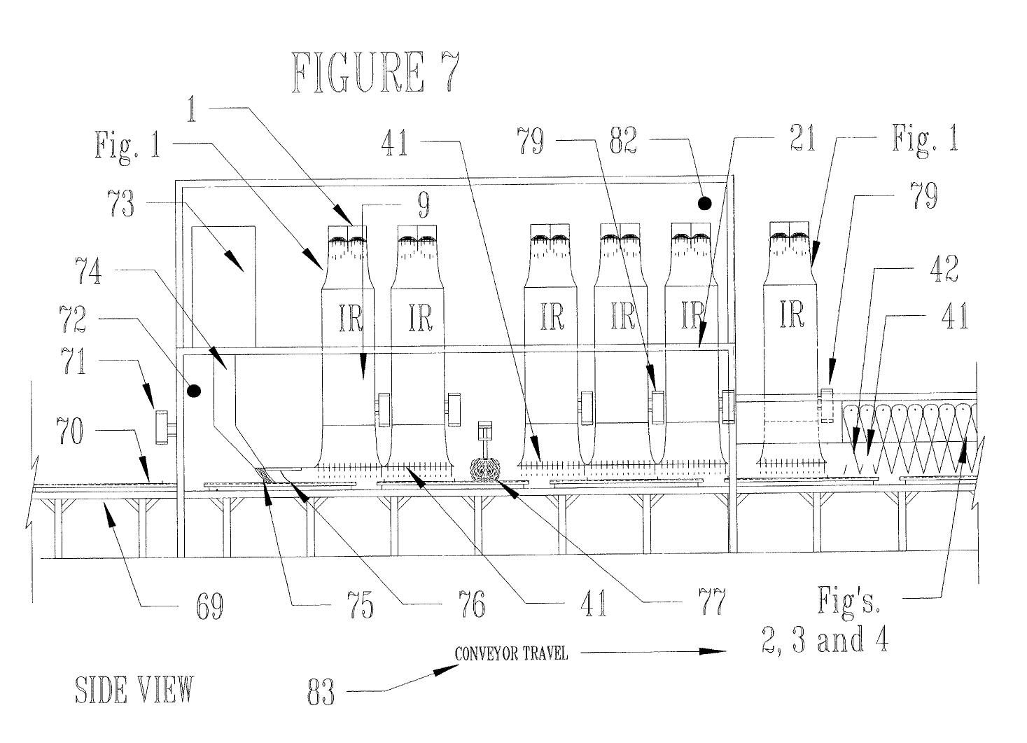

FIG. 7 is an illustration of the invention, and is a processing system variation. FIG. 7 features flatline processing for the horizontal processing of flat products 70 that are indexed or continuously conveyed in the conveyor direction 83 as shown upon a processing conveyor 69. FIG. 7 illustrations assume that the flat parts 70 in process may not have been preheated before entering the spray booth area. However, preheating of the flat part is not precluded as part of the invention as illustrated in FIG. 7. Prior to entering the spray booth area 72, the moisture content of the flat parts 70 is determined by a reading from the moisture sensor scanner 71. This data is queued in a processing system programmable controller in order to make automatic processing decisions for the particular flat part 70 in process. The flat part 70 then enters the spray booth area 72 via the conveyor 69. If the flat part 70 needs supplemental moisturized chilled fluid 75 placed upon the surface of the part 70 to enhance the electrostatic attraction of the particles contained in the powder application cloud 77, the chilled and conditioned fluid 75 is dispensed from the fluid conditioning device 73 through the application nozzle 74 at a similar rate of velocity as that of the movement of the flat part 70. The chilled and conditioned fluid 75 will lay upon the flat part 70 due to its relatively high weight compared to the standard air that is present in the spray booth area 72. If it is desirable to have the chilled and conditioned fluid 75 occupy only recessed areas in the flat part 70, a spreader bar 76 will wipe off the chilled fluid 75, leaving a deposit of said fluid 75 in the recessed areas. The flat parts 70 are then conveyed under a WGCL assembly FIG. 1 for heat processing with infrared radiation 41 that has been generated and guided, in part, from an fluid purged fixture 1 as illustrated in detail in FIG. 1. The infrared radiation 41 will effectively heat the surface of the flat part 70, while efficiently passing through the chilled conditioned fluid 75. This will largely preserve the moisture fluid content in the chilled and conditioned 75 to enhance the electrostatic attraction of the particles contained in the electrically charged powder cloud 77 while generating the desired surface temperatures upon the flat part 70. The flat part 70 then moves to the electrostatically charged powder cloud 77, where the powder coating is applied. The heated surface of the flat part 70 causes the powder particles in the electrostatically charged powder cloud 77 to begin to coalesce upon contact with the surface of the flat part 70. After application of the powder coating, the flat part 70 will continue to be heated with infrared radiation 41 to liquefy the powder and to facilitate its flow out and leveling. Surface temperatures of the flat part 70 are monitored both before and after the application of the powder coating through a plurality of infrared non-contact thermometers 79. The programmable controller also interprets feedback from the infrared thermometers 79 to automatically maintain the surface temperatures of the flat parts 70 in process within adjustable parameters. The flat part 70 continues to be heated with infrared radiation 41 after leaving the spray booth area 72 via a WGCL as previously illustrated in detail in FIG. 1. Fluid purged fixtures as shown in FIGS. 2, 3 and 4, also supply infrared radiation 41 and ultraviolet radiation 42 to the flat part 70 in process. The fluid purged fixtures FIGS. 2, 3 and 4 are used in place of the WGCL FIG. 1 due to the safe distance placement of the devices from the spray booth area 72 and its outer partition limit 21. It is no longer necessary to use the WGCL FIG. 1 device at the minimum safe distance from the spray booth area 72 and its outer partition limit 21, therefore, the smaller and more compact fluid purged fixtures FIGS. 2, 3 and 4 are used. The ultraviolet radiation 42 will react with a photoinitiator that may be present in the liquefied powder coating, acting as a catalyst to the rapid cure of the liquefied powder coating. The photoinitiator applies to UV curable powder coatings, and may not apply to thermally cured powder coatings.

The fluid purged emitter fixtures 1, as illustrated in detail in FIG. 1, are maintained at a safe distance (typically a minimum of five feet) from the spray booth area 72 and its outer extreme partition 21, permitting the safe execution of one or more of the objectives of the invention. The fluid purged emitter fixtures 1 are shown within an air house area 82 that supplies highly filtered low velocity air 9 into the spray booth area 72 via the WGCL FIG. 1.

The fluid purged fixtures FIGS. 2, 3 and 4 continue processing with infrared radiation 41 and/or ultraviolet radiation 42 outside and at a safe distance from the hazardous spray booth area 72 and its outer partition limit 21. Turning to FIG. 6, the surface appearance modification equipment 78, 80 and 81 has been omitted from FIG. 7, but could be included within the process that is illustrated in FIG. 7 with good results.

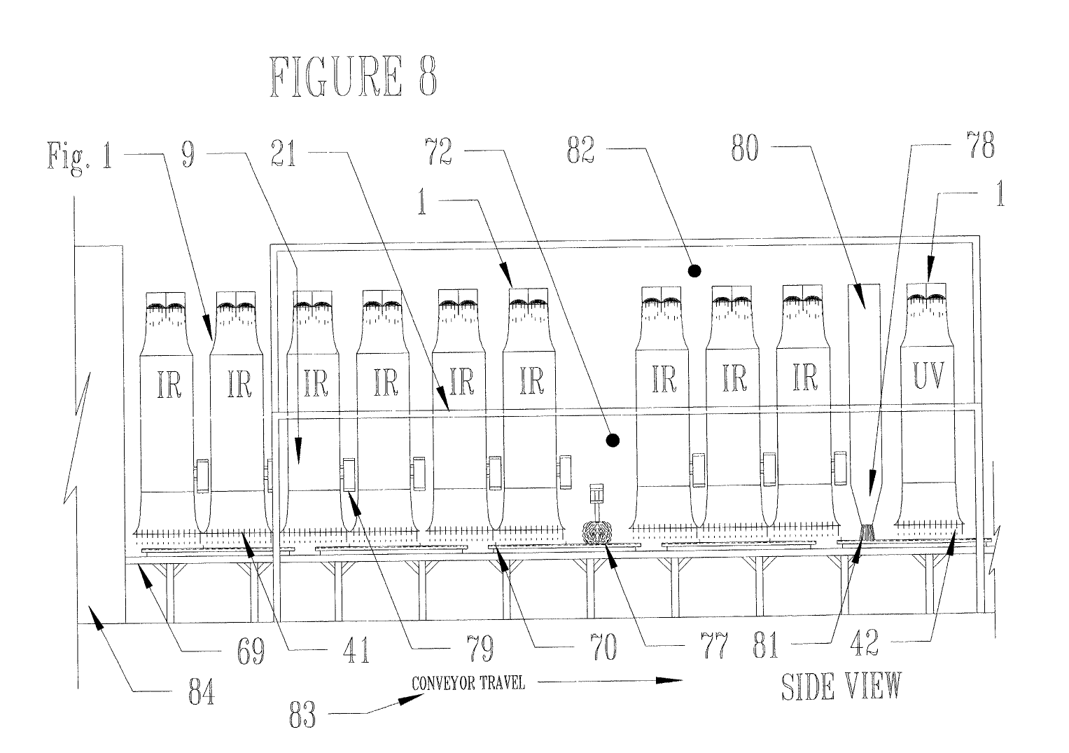

FIG. 8 is an illustration of the invention, and is a processing system variation. FIG. 8 features flatline processing for the horizontal processing of flat products 70 that are indexed or continuously conveyed in the conveyor direction 83 as shown upon a processing conveyor 69. FIG. 8 illustrations assume that the flat parts 70 in process have been preheated by process heating equipment 84 prior to entering the invention shown in FIG. 8. However, preheating of the flat part is not a requirement as part of the invention as illustrated in FIG. 8. As the flat part 70 exits the preheat processing equipment 84 via the processing conveyor 69, the flat part 70 moves underneath a WGCL FIG. 1 and is processed with infrared radiation 41. The infrared radiation 41 shall be introduced upon the surface of the flat part 70 in order to compensate for thermal losses, thereby maintaining the surface temperature of the flat part 70 that was achieved in the preheat processing equipment 84, or for modifying the temperature of the flat parts 70, as the case my be. The flat part 70 then enters the spray booth area 72 via the conveyor 69. The flat parts 70 continue to be conveyed under a WGCL assembly FIG. 1 for heat processing with infrared radiation 41 that has been generated and guided, in part, from an fluid purged fixture 1 as illustrated in detail in FIG. 1. The infrared radiation 41 will effectively maintain the temperature of the surface of the flat part 70, or modify the temperature, as the case may be. This will reduce the need to heat the surface of the flat parts 70 to higher temperatures than desired in the preheat processing equipment 84 in compensation for the temperature drop that has historically occurred between the preheat processing equipment 84 and the electrostatically charged powder cloud 77 without a means to maintain said surface temperatures. The flat part 70 then moves to the electrostatically charged powder cloud 77, where the powder coating is applied. The heated surface of the flat part 70 causes the powder particles in the electrostatically charged powder cloud 77 to begin to coalesce upon contact with the surface of the flat part 70. After the application of the powder coating, the flat part 70 will continue to be heated with infrared radiation 41 to liquefy the powder and to facilitate its flow out and leveling. Surface temperatures of the flat part 70 are monitored both before and after the application of the powder coating through a plurality of infrared non-contact thermometers 79. A programmable controller also interprets feedback from the infrared thermometers 79 to automatically maintain or modify the surface temperatures of the flat parts 70 in process within adjustable parameters. It may be desirable to alter the appearance of the coating upon the surface of the flat part 70. In that event, frigid and conditioned fluid 81 may be dispensed from the frigid and conditioned fluid processing equipment 80 through a nozzle 78 and impinged upon the hot and liquefied coating upon the surface of the flat part 70. The frigid and conditioned fluid 81 will cause the liquefied powder coating to rapidly contract, causing a matte and/or crinkled surface appearance upon the coating upon the flat part 70 in process. As the flat part 70 continues along the conveyor 69, the surface of the coating is exposed to ultraviolet radiation 42 from a fluid purged fixture 1 via another WGCL as previously featured in FIG. 1. The ultraviolet radiation 42 will react with a photoinitiator that may be present in the liquefied powder coating, acting as a catalyst to the rapid cure of the liquefied powder coating. The photoinitiator applies to UV curable powder coatings, and may not apply to thermally cured powder coatings. If surface appearance modifications are desired upon UV curable powder coatings, the rapid cure obtained from the exposure to the ultraviolet radiation 42 will permanently preserve the altered appearance achieved from processing with the frigid and conditioned fluid 81. Appearance changes may also occur upon the surface of thermally cured coatings, but it should be noted that a rapid cure of the powder coating may not occur from exposure to the ultraviolet radiation 42 if no photoinitiator is present within the powder coating chemical formulation.

The fluid purged emitter fixtures 1, as illustrated in detail in FIG. 1, are maintained at a safe distance (typically a minimum of five feet) from the spray booth area 72 and its outer extreme partition 21, permitting the safe execution of one or more of the objectives of the invention. The fluid purged fixtures 1 are shown within an air house area 82 that supplies highly filtered low velocity air 9 into the spray booth area 72 via the WGCL as illustrated in FIG. 1. Turning to FIGS. 6 and 7, the chilled and conditioned fluid 75 that is supplied from the chilled fluid conditioning equipment 73 via the duct and nozzle 74, and that may be further modified by the spreader bar 76, has not been illustrated in FIG. 8, but may be included in the process as illustrated in FIG. 8 if desirable.

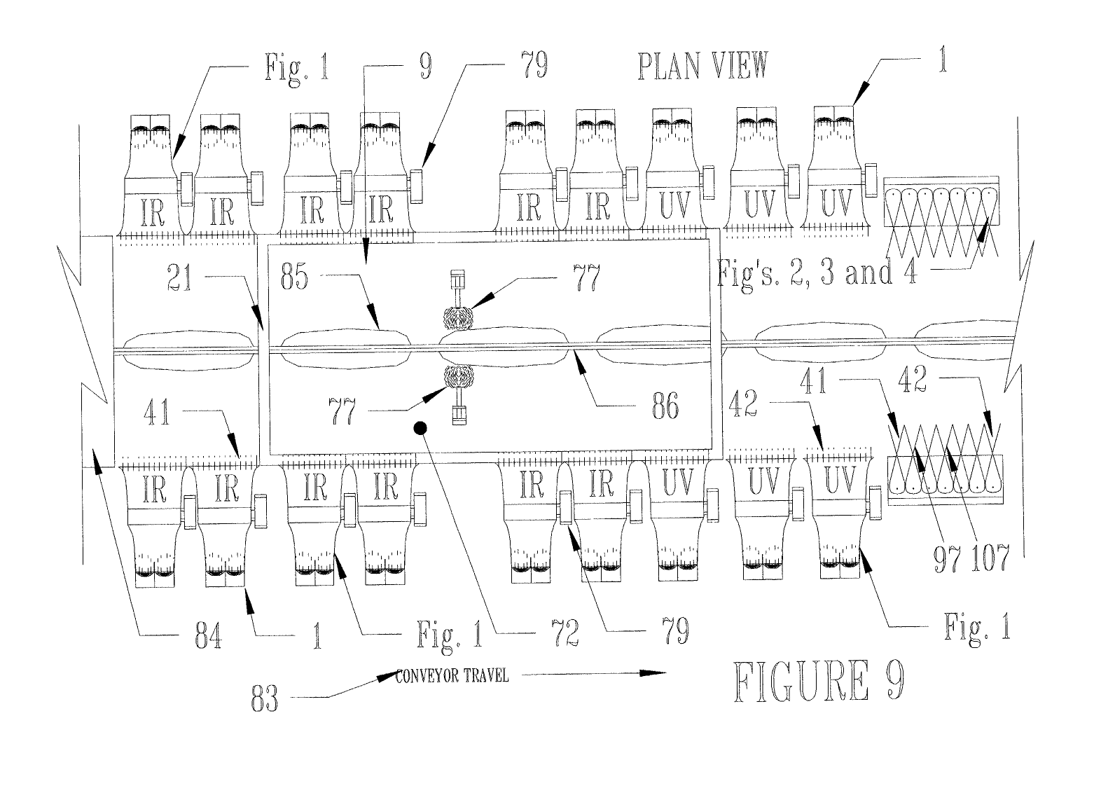

FIG. 9 is a plan view illustration of the invention, and is a processing system variation. FIG. 9 features the processing of hanging parts 85 that are indexed or continuously conveyed by an overhead conveyor 86 in a specific direction 83 as shown. FIG. 9 illustrations assume that the hanging parts 85 in process have been preheated before entering the spray booth area 72 by preheat processing equipment 84. However, preheating of the hanging parts 85 is not a requirement of the invention as illustrated in FIG. 9. As the hanging parts 85 exit the preheat processing equipment 84 via the overhead conveyor 86, the hanging parts 85 pass a series of WGCL FIG. 1 devices and are processed with infrared radiation 41. The infrared radiation 41 is introduced upon the surface of the hanging parts 85 in order to compensate for thermal losses, thereby maintaining the surface temperature of the hanging parts 85 that was achieved in the preheat processing equipment 84, or for modifying the temperature of the hanging parts 85, as the case may be. The hanging parts 85 then enters the spray booth area 72 via the overhead conveyor 86. The hanging parts 85 continue to be conveyed past WGCL devices FIG. 1 for heat processing with infrared radiation 41 that have been generated and guided, in part, from fluid purged fixtures I as illustrated in FIG. 1. The infrared radiation 41 will effectively maintain the temperature of the surface of the hanging parts 85. This will reduce the need to heat the surface of the hanging parts 85 to higher temperatures than desired in the preheat processing equipment 84 in compensation for the temperature drop that has historically occurred between the preheat processing equipment 84 and the electrostatically charged powder cloud 77 without a means to maintain or modify said surface temperatures. The hanging parts 85 then move to the electrostatically charged powder cloud 77, where the powder coating is applied. The heated surface of the hanging parts 85 causes the powder particles in the electrostatically charged powder cloud 77 to begin to coalesce upon contact with the surface of the hanging parts 85. After the application of the powder coating, the hanging parts 85 will continue to be heated with infrared radiation 41 to liquefy the powder and to facilitate its flow out and leveling. Surface temperatures of the hanging parts 85 are monitored both before and after the application of the powder coating through a plurality of infrared non-contact thermometers 79. A programmable controller interprets feedback from the infrared thermometers 79 to automatically maintain or modify the surface temperatures of the hanging parts 85 in process within adjustable parameters. As the hanging parts 85 move through the spray booth area 72 via the overhead conveyor 86, the said parts 85 are then processed with ultraviolet radiation 42. The hanging parts 85 continue to be processed with ultraviolet radiation 42 after leaving the spray booth area 72 via WGCL devices FIG. 1 as previously illustrated in detail in FIG. 1. Fluid purged fixtures as shown in FIGS. 2, 3 and 4, that also supply infrared radiation 41 and ultraviolet radiation 42 to the hanging parts 85 in process. The fluid purged fixtures FIGS. 2, 3 and 4 are used in place of the WGCL devices FIG. 1 due to the safe distance placement of the devices from the spray booth area 72 and its outer partition limit 21. It is no longer necessary to use the WGCL FIG. 1 device at the minimum safe distance from the spray booth area 72 and its outer partition limit 21, therefore, the smaller and more compact fluid purged fixtures FIGS. 2, 3 and 4 are used. The ultraviolet radiation 42 will react with a photoinitiator that may be present in the liquefied powder coating, acting as a catalyst to the rapid cure of the liquefied powder coating. The photoinitiator applies to UV curable powder coatings, and may not apply to thermally cured powder coatings.

In FIG. 9, the fluid purged emitter fixtures 1, as illustrated in detail in FIG. 1, are maintained at a safe distance (typically a minimum of five feet) from the spray booth area 72 and its outer extreme partition 21, permitting the safe execution of one or more of the objectives of the invention. The fluid purged emitter fixtures I are shown that transfer highly filtered low velocity air 9 into the spray booth area 72 via the WGCL FIG. 1. The fluid purged fixtures FIGS. 2, 3 and 4 continue processing with infrared radiation 41 and/or ultraviolet radiation 42, or any other electromagnetic radiation 97, including light 107, outside and at a safe distance from the hazardous spray booth area 72 and its outer partition limit 21. Turning to FIG. 6, the surface appearance modification equipment 78, 80 and 81 has been omitted from FIG. 9, but could be included within the process that is illustrated in FIG. 9 with good results.

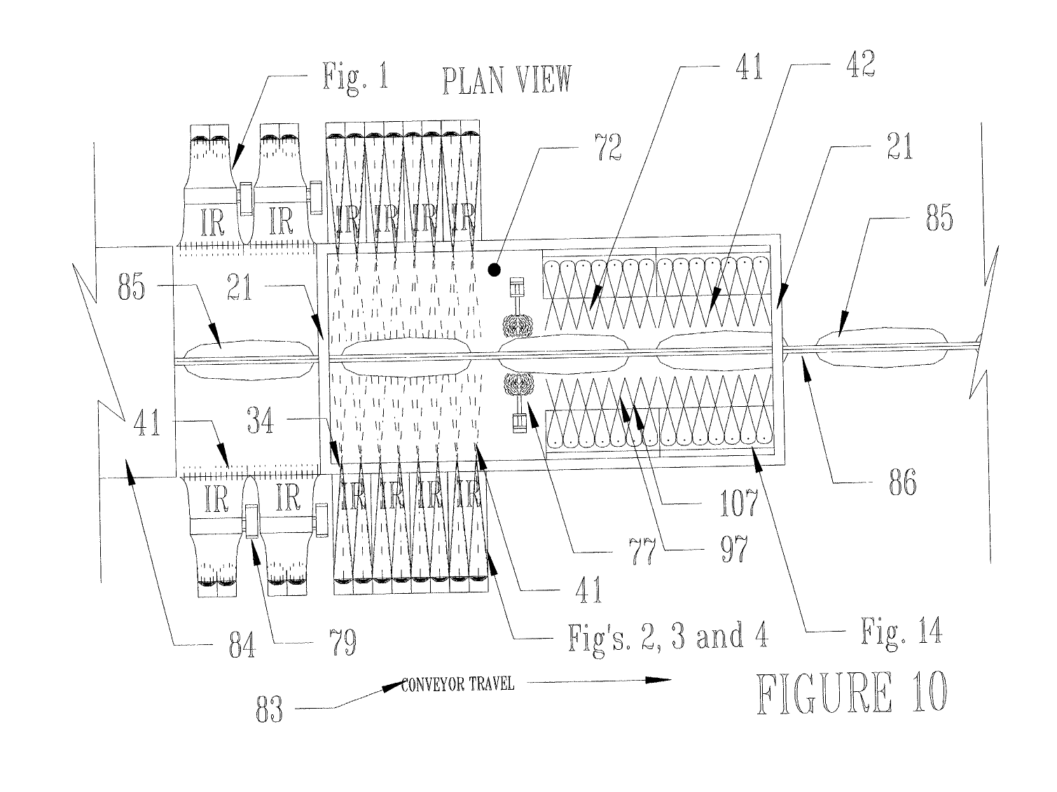

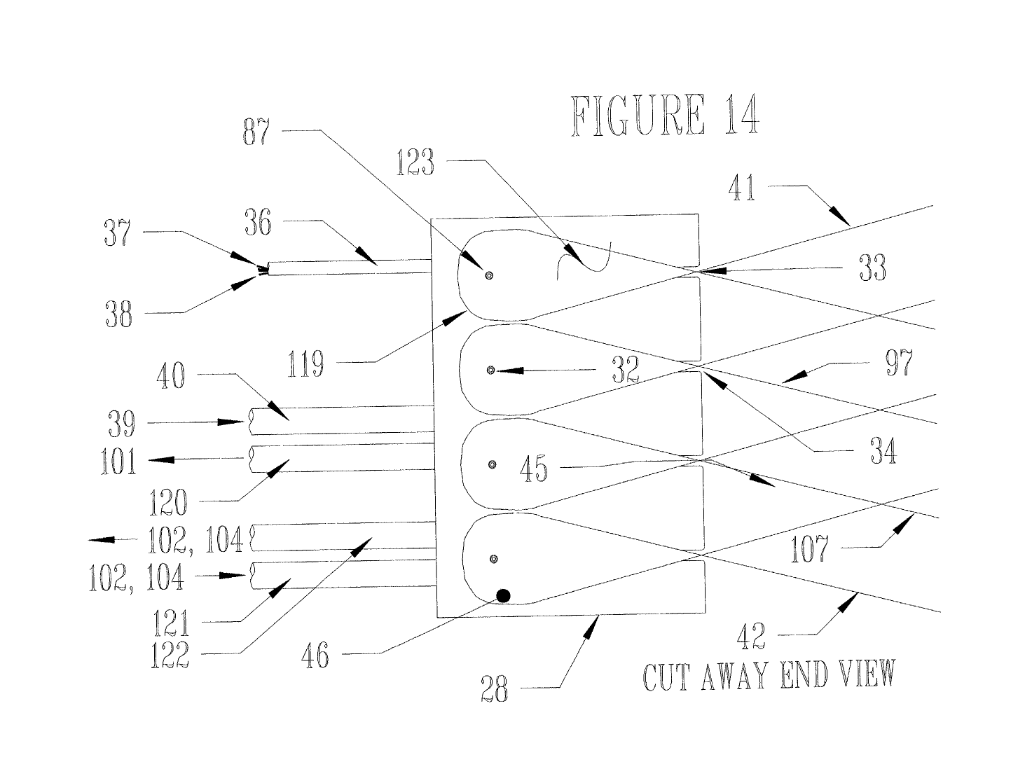

FIG. 10 is a plan view illustration of the invention, and is a processing system variation. FIG. 10 features the processing of hanging parts 85 that are indexed or continuously conveyed by an overhead conveyor 86 in a specific direction 83 as shown. FIG. 10 illustrations assume that the hanging parts 85 in process have been preheated before entering the spray booth area 72 by preheat processing equipment 84. However, preheating of the hanging parts 85 is not a requirement of the invention as illustrated in FIG. 10. As the hanging parts 85 exit the preheat processing equipment 84 via the overhead conveyor 86, the hanging parts 85 pass a series of WGCL FIG. 1 devices and are processed with infrared radiation 41. The infrared radiation 41 is introduced upon the surface of the hanging parts 85 in order to compensate for thermal losses, thereby maintaining or modifying the surface temperature of the hanging parts 85 that was achieved in the preheat processing equipment 84. The hanging parts 85 then enters the spray booth area 72 via the overhead conveyor 86. The hanging parts 85 continue to be conveyed past fluid purged fixtures FIGS. 2, 3 and 4 for heat processing with infrared radiation 41 that passes through a fluid purged slot 34 located in the spray booth partition 21. The infrared radiation 41 will effectively maintain or modify the temperature of the surface of the hanging parts 85 as desired. This will reduce the need to heat the surface of the hanging parts 85 to higher temperatures than desired in the preheat processing equipment 84 in compensation for the temperature drop that has historically occurred between the preheat processing equipment 84 and the electrostatically charged powder cloud 77 without a means to maintain said surface temperatures. The hanging parts 85 then move to the electrostatically charged powder cloud 77, where the powder coating is applied. The heated surface of the hanging parts 85 causes the powder particles in the electrostatically charged powder cloud 77 to begin to coalesce upon contact with the surface of the hanging parts 85. After the application of the powder coating, the hanging parts 85 will continue to be heated with infrared radiation 41 to liquefy the powder and to facilitate its flow out and leveling. Surface temperatures of the hanging parts 85 are monitored both before and after the application of the powder coating through a plurality of infrared non-contact thermometers 79. A programmable controller interprets feedback from the infrared thermometers 79 to automatically maintain or modify the surface temperatures of the hanging parts 85 in process within adjustable parameters. Fluid purged and fluid cooled emitter fixtures FIG. 14 replace both the WGCL devices FIG. 1 and the fluid purged fixtures FIGS. 2, 3 and 4 due to their special construction features for use inside of the hazardous spray booth area 72. The fluid purged and fluid cooled emitter fixtures FIG. 14 may be used for emitting infrared radiation 41 and/or ultraviolet radiation 42 or any other electromagnetic radiation 97, including light 107. The ultraviolet radiation 42 will react with a photoinitiator that may be present in the liquefied powder coating, acting as a catalyst to the rapid cure of the powder coating. The photoinitiator applies to UV curable powder coatings, and may not apply to thermally cured powder coatings.

In FIG. 10, the fluid purged and fluid cooled emitter fixtures as illustrated in detail in FIG. 14 are safely used inside of the spray booth area 72 and within its outer extreme partition 21, permitting the safe execution of one or more of the objectives of the invention. Turning to FIG. 6, the surface appearance modification equipment 78, 80 and 81 has been omitted from FIG. 10, but could be included within the process that is illustrated in FIG. 10 with good results.

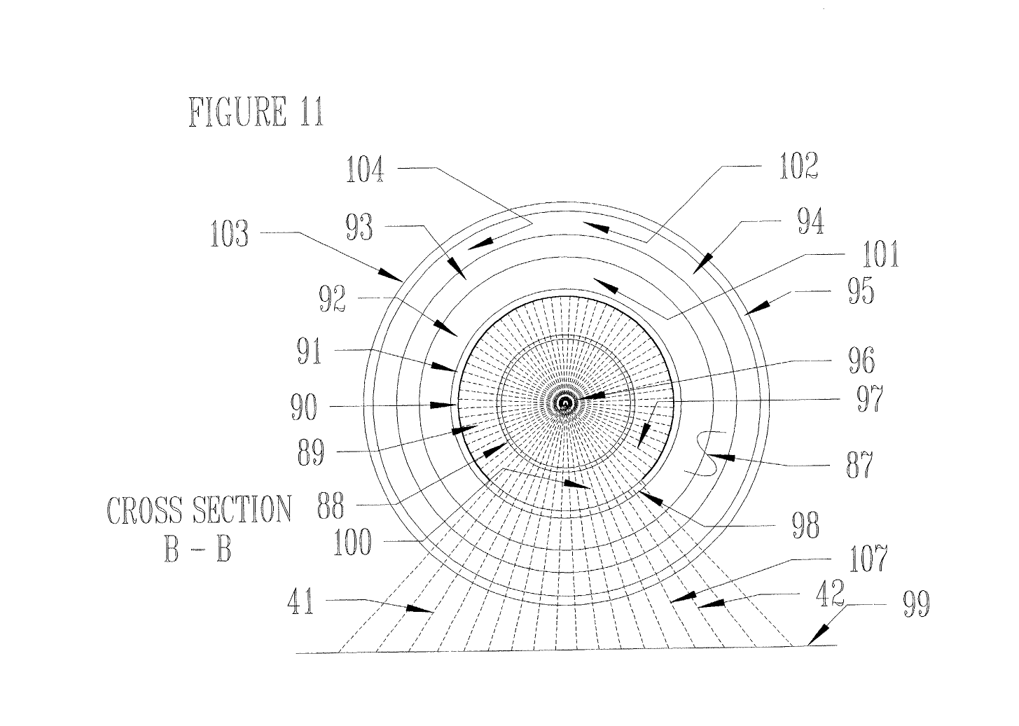

FIG. 11 is a cross-section B-B that illustrates an explosion-proof and fluid cooled electromagnetic emitter device 87. An emitter energy source 96 is contained within an envelope 88 that protects the emitter energy source 96. The protective envelope 88 is constructed of a material that will transmit the radiant energy waves 97 with high efficiency. The protective envelope 88 is typically sealed at both ends and often contains halogen gas within the sealed envelope 88. The protective envelope 88 is contained within another tube 91 that contains an integral gold film reflector 90 that has been applied to the inner surface of the tube 91. The tube 91 will also transmit the radiant energy waves 97 with high efficiency. A cooling fluid supply space 89 is created between the inner envelope 88 and the tube 91 that is purged with cooling fluid 100. The cooling fluid 100 is typically a gas. The cooling fluid 100 will cool the inner envelope 88, the tube 91 that contains the integral gold reflective film 90, the integral gold reflective film 90 itself, and assist in lowering the temperature of the entire explosion-proof and fluid cooled electromagnetic emitter device 87 to prevent overheating of said device. The cooling fluid 100 will leave the cooling fluid supply space 89 by exiting exhaust ports 98 that are located in the tube 91 that surrounds the protective envelope 88. Radiant energy waves 97 that are emitted from the radiant energy source 96 strike the integral gold reflective film 90 and are reflected toward a target surface 99. The tube 91 that contains the integral gold reflector film 90 may be closed at both ends while containing the inner envelope 88 and the radiant energy source 96, or in some cases, may not be closed, permitting replacement of said inner envelope 88, and its contents, at the end of its expendable life. A thick walled tube 93 surrounds both the protective envelope 88 and the tube 91 that contains the integral gold reflective film reflector 90. A cooling fluid exhaust space 92 is created between the thick walled tube 93 and the tube 91 that contains the integral gold reflective film 90. The cooling fluid 100 enters the cooling fluid exhaust space 92 after passing through the exhaust ports 98, and becomes cooling fluid exhaust 101. The thick walled tube 93 is capable of containing an explosion that may occur from within the aforementioned emitter energy source 96, protective envelope 88, cooling supply fluid space 89, exhaust ports 98, the tube 91 that contains the integral gold reflective film 90, and the exhaust cooling fluid space 92. The thick walled tube 93 will transmit the radiant energy waves 97 that are generated from the emitter energy source 96 with high efficiency. An outer tube 95 surrounds the thick walled tube 93 that forms an outer fluid cooling space 94. The thick walled tube 93 and the outer tube 95 shall be sealed at both ends forming a liquid tight seal between them for their entire circumference, but only within the space between the thick walled tube 93 and the outer tube 95. The seals shall form the liquid tight cooling fluid space 94, and each seal on each end shall contain at least one fluid port to accommodate the flow of a cooling fluid liquid 102 or gas 104. The radiant energy waves 97 will pass through the outer fluid cooling space 94, the cooling fluid liquid 102 and/or gas 104, and the outer tube 95 in order to strike a target surface 99 for processing with infrared radiation 41 or ultraviolet radiation 42. The outer surface 103 of the outer tube 95 will be maintained below the temperatures prescribed by NEMA, NFPA, or other regulatory safety agencies during operation. Acceptable outer surface 103 operating temperatures of below 192° F. and the ability to contain an explosion within the explosion-proof and fluid cooled electromagnetic emitter device 87 shall enable its safe use within hazardous NEMA classified areas. The radiant energy waves 97 may be infrared radiation 41, ultraviolet radiation 42, or a combination of both infrared radiation 41 and ultraviolet radiation 42, or any electromagnetic radiation, including light 107.

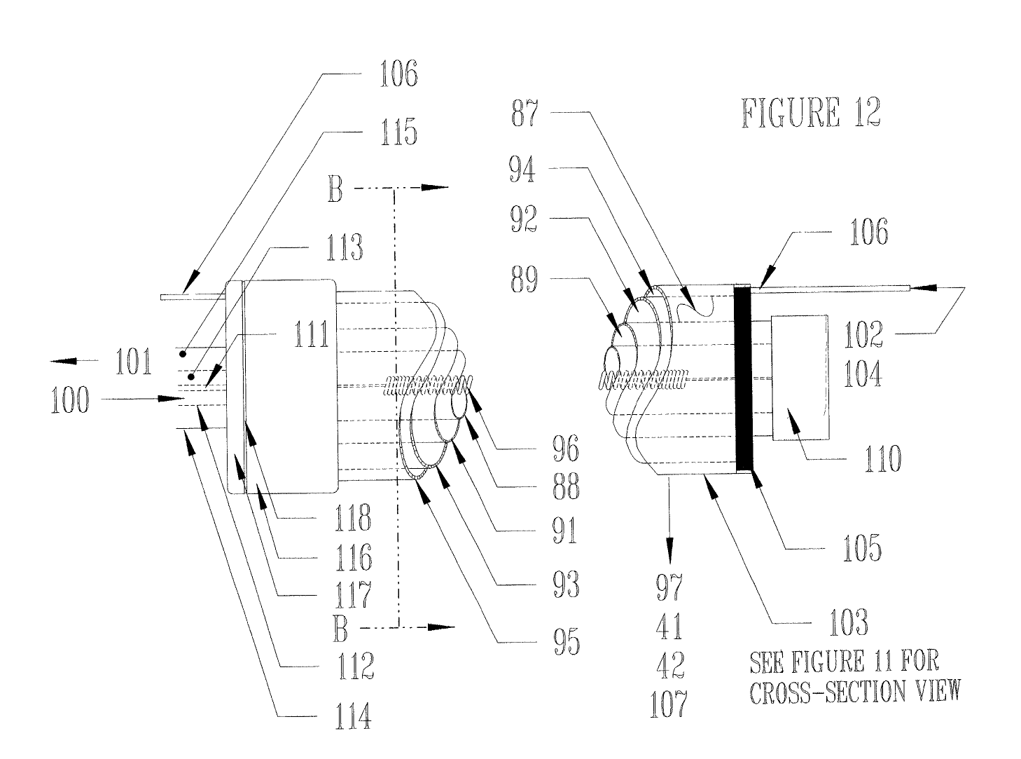

FIG. 12 illustrates an explosion-proof and fluid cooled electromagnetic emitter device 87. An emitter energy source 96 is contained within an envelope 88 that protects the emitter energy source 96. The protective envelope 88 is constructed of a material that will transmit radiant energy with high efficiency. The protective envelope 88 is typically sealed at both ends and often contains halogen gas within the sealed envelope 88. The protective envelope 88 is contained within another tube 91 that contains an integral gold film reflector 90 (not visible in this view) that has been applied to the inner surface of the tube 91. The tube 91 will also transmit radiant energy waves with high efficiency. A cooling fluid supply space 89 is created between the inner envelope 88 and the tube 91. The tube 91 that contains the integral gold reflector film 90 may be closed at both ends by an end cap 110 while containing the inner envelope 88 and the radiant energy source 96. The end cap 110 is constructed of a high temperature and electrically conductive material, such as stainless steel, and may be removable to permit replacement of said inner envelope 88, and its contents. A thick walled tube 93 surrounds both the protective envelope 88 and the tube 91 that contains the integral gold reflective film reflector 90. A cooling fluid exhaust space 92 is created between the thick walled tube 93 and the tube 91. The thick walled tube 93 is capable of containing an explosion that may occur from within the aforementioned emitter energy source 96, protective envelope 88, cooling supply fluid space 89, exhaust ports 98, the tube 91 that contains the integral gold reflective film 90, and the exhaust cooling fluid space 92. The thick walled tube 93 will transmit the radiant energy waves that are generated from the emitter energy source 96 with high efficiency. An outer tube 95 surrounds the thick walled tube 93 that forms an outer fluid cooling space 94. The thick walled tube 93 and the outer tube 95 shall be sealed 105 at both ends forming a liquid tight seal between them for their entire circumference, but only within the space between the thick walled tube 93 and the outer tube 95. The seals 105 shall dam the liquid tight cooling fluid space 94, and each seal 105 on each end shall contain at least one fluid port tube 106 to accommodate the flow of a cooling fluid liquid 102 or gas 104. The radiant energy waves will pass through the outer fluid cooling space 94, the cooling fluid liquid 102 and/or gas 104, and the outer tube 95. The outer surface 103 of the outer tube 95 will be maintained below the temperatures prescribed by NEMA, NFPA, or other regulatory safety agencies during operation. Acceptable outer surface 103 operating temperatures of below 192° F. and the ability to contain an explosion within the explosion-proof and fluid cooled electromagnetic emitter device 87 shall enable its safe use within hazardous NEMA classified areas. The radiant energy waves 97 may be infrared radiation 41, ultraviolet radiation 42, or a combination of both infrared radiation 41 and ultraviolet radiation 42, or any electromagnetic radiation 97, including light 107.

Each end of the invention has an outside end closure body 116 and an end closure plate 117 to provide for electrification of the radiant energy source 96 and to accommodate the insertion and removal of the cooling fluid 100 and cooling fluid exhaust 101. A power wire 111 is located on each end of the explosion-proof and fluid cooled electromagnetic emitter device 87 that is connected to the electrically conductive end cap 110. The power wire 111 is contained with the cooling fluid supply tube 112. The cooling fluid supply tube 112 contains a space 113 between the power wire 111 and the interior of cooling fluid supply tube 112 that accommodates the flow of the cooling fluid 100. The power wire 111 and the cooling fluid supply tube 112 are both contained within the cooling fluid exhaust tube 114. The cooling fluid exhaust tube 114 contains a space 115 between the cooling fluid supply tube 112 and the interior surface of the cooling fluid supply tube 114 that accommodates the flow of exhaust fluid 101. The end closures 116 and 117 have been removed from the right end of the invention in FIG. 12 in order to display the end cap 110 in the illustration. The cooling fluid supply tube 112 and the cooling fluid exhaust tube 114 are constructed of high temperature material that possesses high dielectric strength, such as silicone. The electrical wire 111 and the cooling tubes 112 and 114 are shown in a concentric configuration, but each may be separately attached to the end closure cap 117. The end closure cap 117 is a flat plate with a centrally located hole that allows the cooling fluid exhaust tube 114 and its contents to protrude out of the end closure 117 (hole not shown). Another hole exists in the end closure 117 that permits the fluid port tube 106 to protrude through the end closure plate 117. A gasket 118 provides a seal between the end closure body 116 and the end closure plate 117, and between the fluid port tube 106 and the end closure plate 117. The end closure plate 117 is fastened to the end closure body 116 with screws (not shown).

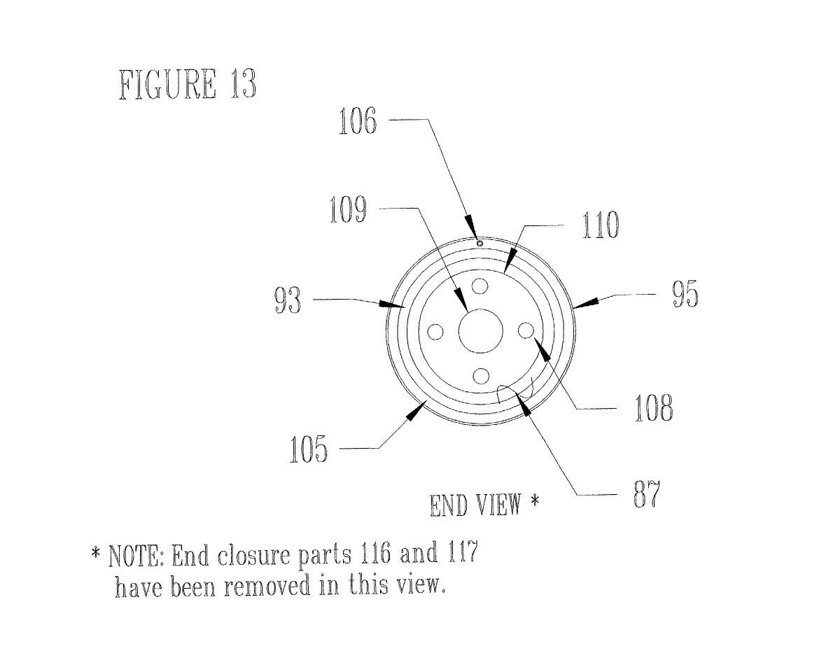

FIG. 13 is an end view of the explosion-proof and fluid cooled electromagnetic emitter device 87 without the end closure body 116 or the end closure plate 117 attached for illustrative purposes. A cooling fluid inlet port 109 is centrally located within the end cap 110 in a concentric manner to allow the cooling fluid 100 (not shown) to enter into the emitter. The cooling fluid exhaust 101 (not shown) exits the end cap 110 through a plurality of exhaust holes 108. The end cap 110 is concentrically held into position by the end closure plate 1 17 and the end closure body 1 16 (both omitted for illustrative purposes). The cooling port tube 106 is shown while installed within the seal 105 that resides between the outer tube 95 and the thick walled tube 93.

FIG. 14 illustrates a cut away end view of an fluid purged and fluid cooled emitter fixture 123 for containing, supporting, cooling, protecting and electrifying explosion-proof and fluid cooled electromagnetic emitter devices 87 in environments that contain high concentrations of gases and airborne particulate matter, such as powder coating particles. The invention consists of fixture housing 28 constructed of a noncombustible material of high structural strength, such as metal or metal alloy. The fixture housing 28 contains a fluid cooled reflector system 119 that is capable of focusing electromagnetic energy, specifically infrared radiation (IR) 41 and ultraviolet radiation (UV) 42, or any other form of electromagnetic energy 97, including light 107. The explosion-proof and fluid cooled electromagnetic emitter 87 is located at the primary focal point 32 of the reflector system 119. The radiation 97 is highly focused to a secondary focal point 33. The radiation 97 then experiences an image reversal beyond the secondary focal point 33 where it crosses over and expands over a larger area as it passes through a fluid purged slot 34. The fixture housing 28 is fluid purged by forcing the purging supply fluid 39 (often air) into the fluid supply piping 40. The purging supply fluid 39 is uniformly distributed to each end of the emitters 87 and becomes the previously described cooling fluid 100 upon entering said emitters 87, and to each end of the reflector chambers 46 in order to provide a positive pressure relative to the ambient atmosphere in which the invention is located. The pressurized supply fluid 39 in each reflector chamber 46 then passes through a plurality of fluid purge slots 34 as fluid purge exhaust 45. The emitter exhaust fluid 101 that exits the explosion-proof and fluid cooled electromagnetic emitter device 87 is contained and channeled through the fluid outlet tube 120. Cooling fluid liquid 102 (often water) or cooling fluid gas 104 flows into the cooling fluid inlet piping 121 and is equally distributed to each of the explosion-proof and fluid cooled electromagnetic emitter devices 87 and separately and equally to the fluid cooled reflectors 119. All cooling fluid liquid 102 or the cooling fluid gas 104 then combines and exits through the outlet tube 122. The electrical power is distributed to the electromagnetic emitters 87 through the IR electrical wiring 37 and 38, which is contained by airtight electrical conduit 36. The IR emissions 41 UV emissions 42 light emissions 107 or any other form of electromagnetic radiation 97 emerge from the fluid purged slots 34 in conjunction with the fluid purging exhaust 45. The fluid purging exhaust 45 escapes through the fluid purged slots 34 at increased velocity relative to the pressurized purging fluid 39 within the reflector chambers 46. The high velocity fluid purging exhaust 45 prevents the intrusion of potentially explosive airborne particulate matter and gasses into the fixture housing 28 and reflector chambers 46. The surface temperature of the device is maintained at acceptable temperatures during operation, making it suitable for use within hazardous NEMA classified areas.

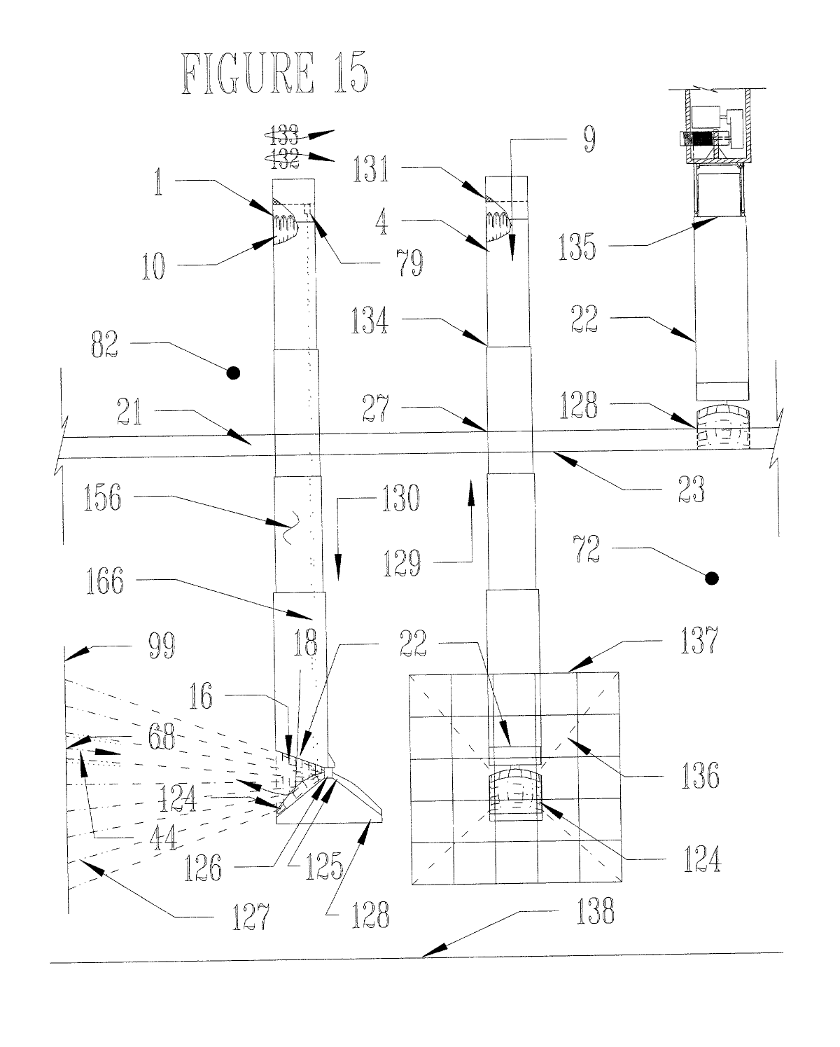

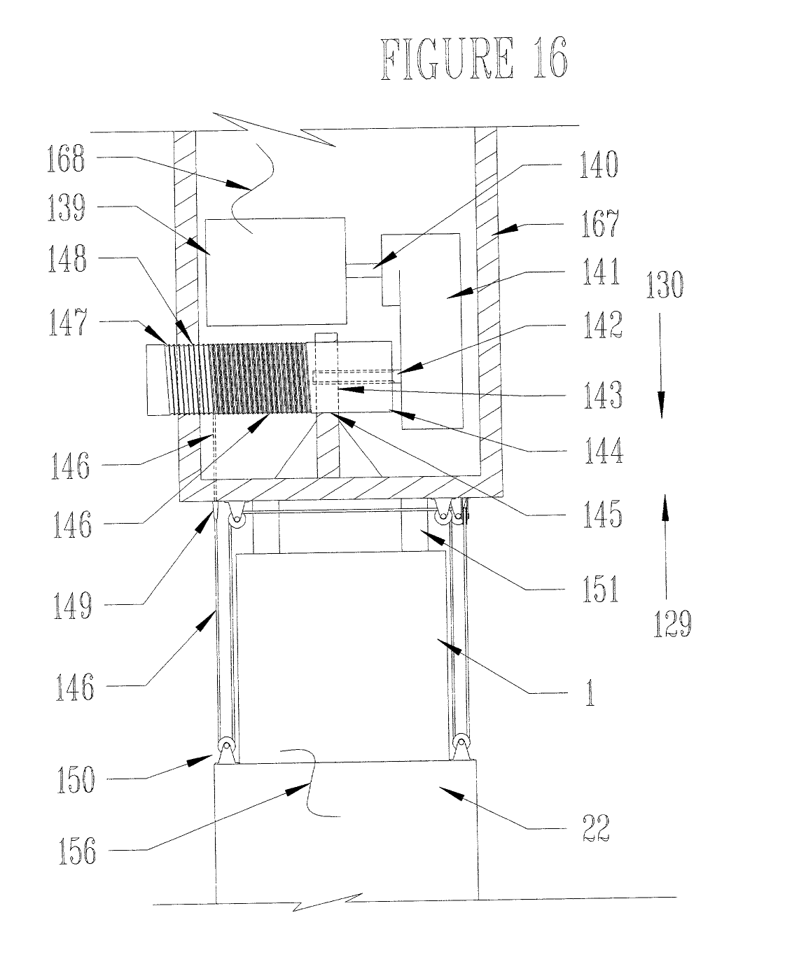

FIG. 15 is an illustration of a practical variation of the invention. FIG. 15 shows an electromagnetic emitter fixture assembly 1 mounted on the upper end of a wave guide body 4 device that is intended to transfer electromagnetic radiation 10, such as infrared radiation and/or ultraviolet radiation, into a normally hazardous spray booth area 72 for industrial processing reasons. The electromagnetic emitter fixture assembly 1 contains a plurality of emitter devices, both of which assist in the emission of highly aligned electromagnetic radiation 16 that is directed into the wave guide body 4. A cooling fluid 9 (typically filtered and conditioned air) is inserted into the wave guide body 4 from the air house area 82 by first passing through an efficient filter 131 to remove unwanted particulate matter. The cooling fluid 9 passes through the wave guide body 4 and exits at the delivery end 22 of the wave guide body 4 as exhaust purge fluid 18 at low velocity to keep any particulate matter, such as liquid and/or powder paint material from drifting into the device. The wave guide body 4 is capable of telescoping upward 129 or downward 130 upon command from the operators of said equipment (see FIG. 16 for details about mechanical movement of telescoping device). Note that there are no electrical wires within the wave guide device 156 or located within the hazardous spray booth area 72. No electrical devices are located within five feet of the hazardous spray booth area 72. The telescopic wave guide device 156 is constructed of square, round, rectangular, or ovular shaped interlocking stages 134 that fit within one another. The wave guide device 156 can be telescoped upward 129 or telescoped downward 130 and positioned at a convenient height for use within the hazardous spray booth area 72, and remain at a given position until such time that the operator of the spray booth area 72 desires to modify its height. The entire wave guide device 156 can also be rotated in a clockwise 132 or counterclockwise 133 direction as needed during operation. This may be accomplished automatically through the use of a linear actuator (not shown) or other powered device that is located at a safe distance from the hazardous spray booth area 72. The location of the electromagnetic emitter fixture 1 end of the wave guide device 156 may be located at virtually any reasonable distance from the spray booth area 72 and the air house area 82, and may be outside of both of these areas, if it is desirable or required to place the electromagnetic emitter fixture 1, or any related electrical wiring, hot surfaces, or devices that could create an electrical spark, or otherwise be a safety hazard, at a specified distance away from the furthest outside partition of the air house area 82. This could be, for example, a five foot distance from the roof of the air house area 82.

The electromagnetic radiation 10 is transferred from the fixture 1 through the wave guide body 4 and then exits the wave guide device 156 at the delivery end 22. The aligned electromagnetic radiation 16 is then redirected at various strategic angles for use within the spray booth area 72. The radiation 16 is also strategically expanded 136 over a significantly larger area in order to spread the energy over a larger target surface 99 area during its use within the spray booth area 72. This is accomplished by directing the electromagnetic radiation 16 onto a strategically designed convex reflective surface 124. The convex reflective surface 124 may alternatively be concave, flat, or any combination of these, in order to efficiently and strategically redirect the electromagnetic radiation 16 as needed for processing within the spray booth area 72. The said reflective surface may modify the direction of the electromagnetic radiation 16 without expanding it, or may concentrate the electromagnetic radiation 16 into a smaller pattern for increased density per square area of measurement relative to the power density per square area of measurement as measured at the original power source within the electromagnetic fixture 1. FIG. 15 features an expansion factor of 1:25, where the electromagnetic emissions 10 from a fixture 1 measuring one (1) square foot is expanded to a pattern of radiation 137 measuring twenty-five (25) square feet at a distance of five feet when directed toward a flat vertical target surface 99. The side view of the wave guide device 156 (on left of FIG. 15) illustrates the dispersion 127 of aligned electromagnetic radiation 16 as viewed from the side of the device. The front view (center of FIG. 15) illustrates the pattern of electromagnetic radiation 137 when striking a theoretical flat and vertical surface 99 that is generally positioned perpendicularly to the radiant emission 16 that is dispersed 127 from the convex reflective surface 124. A turret system 128 contains an additional reflective surface 125 that may disperse the properly aligned electromagnetic radiation 16 in a different manner than the convex reflective surface 124 shown in use in FIG. 15. This additional reflective surface 125 may be strategically designed to expand the electromagnetic radiation 16 over a different area as measured in square units and/or provide a different pattern shape than the convex reflective surface 124 shown in use. This may accommodate different target sizes and/or distances from the reflective surface due, in part, to the varied dimensional sizes of various target objects in process with the spray booth area 72. The operator of the spray booth area 72 may rotate the turret system 128 at the turret swivel device 126 to use a different reflective surface 125 automatically and/or manually. The reflective surfaces 124 and 125 within the turret system 128 will be highly reflective to the particular peak wavelengths of electromagnetic radiation 16 that may be used. If aligned process radiation 16 is infrared radiation, the convex reflective surface 124 and additional reflective surfaces 125 will likely be plated with 24K gold in order to maximize reflectivity of said radiation 16 and to minimize the absorption of infrared energy by the reflective surfaces 124 and 125. The gold can be deposited upon the reflective surfaces 124 and 125, where the reflective surface's substrates are constructed from a material possessing rapid thermal conductivity, such as aluminum, copper, stainless steel, or a composite material, including ceramics and/or metal and ceramic alloys (cermet). It should be noted that during the continuous delivery of high density electromagnetic radiation 10, specifically within the infrared spectrum, the wave guide body 4 and the reflective surfaces 124 and 125 that redirects and possibly modifies the radiant pattern of electromagnetic radiation 137 shall remain within temperatures that are acceptable for use within the hazardous spray booth area 72. Infrared radiation is not heat, but only an energy that is capable of producing heat with an object that is capable of absorbing the infrared energy. If absorption of the infrared radiation is low, then the temperatures generated within the wave guide body 4 and convex reflective surface 124, and the additional reflective surfaces 125 will be low. The substrates to the reflective surfaces 124 and 125 within the turret system 128 shall be capable of efficiently conducting unwanted heat build-up within said devices away from the reflective surfaces 124 and 125 to maintain acceptable surface temperatures of the wave guide device 156 for safe use within the hazardous spray booth area 72. The convex reflective surface 124, the additional reflective surfaces 125, and their substrate structures may be air and/or water cooled to assist in the maintenance of acceptable equipment surface temperatures.

Remaining with FIG. 15, a method for measuring the temperature of a target surface 99 is illustrated. An infrared non-contact thermometer 79 is strategically positioned within the electromagnetic emitter fixture assembly 1 so it may receive long wave infrared 44 energy that is emitted from a specific area 68 of the target surface 99 in process. The infrared non-contact thermometer 79 is well known within the relevant industry, and often contains a lens system to focus the long wave infrared 44 emissions from the target surface 99 into the said instrument. The illustration shows a narrow field of view 166 that is used to collect the long wave infrared 44 radiation that is emitted from the specific area 68 of the target surface 99. The long wave infrared 44 from the specific area 68 of the target surface 99 also strikes the same convex reflective surface 124 simultaneously to the more powerful electromagnetic radiant energy 10 that is used for processing the target surface 99. The long wave infrared 44 radiation that is emitted from the specific area 68 of the process surface 99 travels at approximately the speed of light to the convex reflective surface 124 and is reflected into the telescoping wave guide 4, but is generally traveling in the opposite direction as the electromagnetic radiation 10 energy that is used for processing the target object 99. The long wave infrared 44 radiation that is emitted from the target surface 99 is generally in the peak wavelength range of 7 to 20 microns in length, where the higher the temperature of the target surface 99, the shorter is the peak wavelength of the long wave infrared 44 radiation. The spectral response of 7 to 20 microns of the non-contact infrared thermometer 79 is substantially different than the peak wavelength range of the electromagnetic radiation 10 energy that is used for processing the target surface 99, which is typically in a range of 0.76 micron to 7 microns in length. The non-contact infrared thermometer's 79 field of view 166 is positioned to accurately receive the long wave infrared 44 radiation that is emitted from the specific area 68 of the target surface 99 and reflected by the convex reflective surface 124 into the field of view 166 of the non-contact infrared thermometer 79. The peak wavelengths of the long wave infrared 44 radiation that are received and interpreted are directly proportional to the actual surface temperature of the target surface 99. This precise temperature information can be used for open loop and/or closed loop control of the power levels of the electromagnetic radiant energy 10 that is used for processing the target object 99, thereby permitting manual and/or automatic control of the temperature of the target surface 99 in a precise and strategic manner. The electromagnetic radiant energy 10 and long wave infrared 44 energy that are simultaneously present and traveling in substantially opposite directions, at the speed of light, are successfully manipulated by strategic reflection from the same convex reflective surface 124 without conflict. Thus is the nature of electromagnetic radiation, whose coexistence of altered energies in space and time maintain separate, distinct, and interpretable identities. This given natural property enables the simultaneous transfer of substantially different electromagnetic energies 44 and 10 within the same wave guide device 156 for accurately and safely processing a target surface 99 without the need for the placement of electrical wires, or other hazardous items, within the hazardous spray booth environment 72.

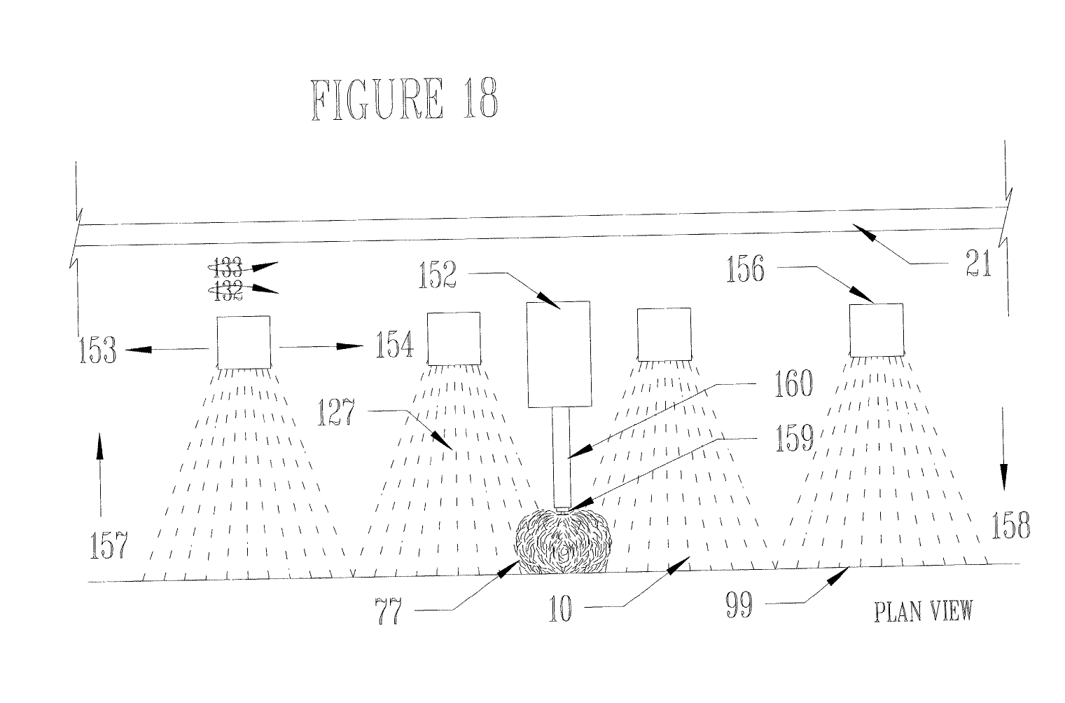

The purpose of using a high density electromagnetic emitter fixture assembly 1 and then expanding 136 the high density electromagnetic radiant energy 10 and 16 over a larger area is to minimize the need for a large and contiguous sheet metal structure that would inhibit visual and physical access to the target object 99 in process within the spray booth area 72. Further, it may be desirable to strategically locate the wave guide devices 156 directly adjacent to the electrostatic powder paint cloud (not shown in FIG. 15) so that electromagnetic process radiation 10 and 16 can be applied to the target surface 99 in process before, during, and after the application of the liquid and/or powder coating material. The small size of the wave guide device 156 that expands the powerful electromagnetic radiant energy 10 and 16 emissions from their small fixtures 1 (one foot square in this example) to that of a significantly larger process emission pattern 137 of 25 square feet creates tremendous efficiencies for the size of the processing equipment, its expense, and convenience of location in relation to other critical processing equipment within the spray booth area 72. One wave guide device 156 possessing a 15 square inch footprint (see FIG. 18) is capable of providing radiant processing emissions that previously required a solid wall of equipment measuring about 66″ high×78″ Tall×18″ Deep. The wave guide devices 156 contains no electrical wires, no objectionable surface temperatures, and expels no objectionably hot fluids, enabling it to be appropriate for processing within the hazardous spray booth area 72. The latter described conventional radiation equipment is not appropriate for use in the hazardous spray booth area 72 and has been prohibited from the spray booth environment 72. Therefore, the invention now permits powerful levels of electromagnetic radiation 10 and 16 for processing within normally hazardous spray booth areas 72 so that new processing advantages can be gained for new coating products on temperature sensitive substrates, such as wood and wood-based products.

Remaining with FIG. 15, the wave guide device 156 can be fully retracted 135 so that the bottom of the reflective surface turret system 128 is flush with the ceiling 23 of the hazardous spray booth area 72, as shown on the right side of FIG. 15. The telescoping feature shows the lower delivery end 22 of the wave guide device 156 fully retracted 135 into the ceiling 23 and residing within the air house area 82.

FIG. 16 illustrates a method to raise and lower the telescopic wave guide device 156 with a power mechanical device 168. The delivery end 22 of the wave guide device 156 is suspended by a cable 146 that is laced through a plurality of pulleys 150 around the perimeter of the delivery end 22 of the wave guide device 156 and the main structure 167 support frame of the power mechanical device 168. One end of the suspension cable 146 is fixed to the main structure 167 by means of a cable fastener 149 and the other end is fastened to a rotating drum 144 that is actuated by an electric motor 139 and gear reduction system 141. The rotating drum 144 contains screw threaded cable grooves 147 that are sufficiently deep to accommodate the suspension cable 146. A similarly threaded hole 148 exists in the main structure 167 wall that supports one end of the rotating drum 144. As the rotating drum 144 turns, it screws in or out, as the case may be, of the threaded hole 148, thereby maintaining the alignment of the suspension cable 146 in a consistent position relative to the entire power mechanical device 168. The opposite end of the rotating cable drum 144 is also supported by passing through an opening 145 in the cable drum support member 143. This specific end of the rotating cable drum 144 is not threaded, but fits through the opening 145 with a minimum of dimensional tolerance. As the cable drum 144 rotates, it slides within the opening 145 in the cable drum support member 143. A reversible spark-proof electric motor 139 provides rotational power through a motor shaft 140 that is connected to a gear reduction drive 141. A splined power transfer shaft 142 transfers power from the gear reduction drive 141, where the splined power transfer shaft 142 does not make lateral movement with the rotating cable drum 144. The splined area within the rotating drum 144 slides laterally upon the splined power transfer shaft 142 as it moves back and forth, as the case may be. The electromagnetic emitter fixture assembly 1 is attached to the main structure 167 of the power mechanical device 168 and suspended by means of multiple structural support members 151. The lower delivery end 22 of the wave guide device 156 can be telescoped upward 129 or downward 130 as desired for repositioning or for tracking a moving target. The main structure 167 of the power mechanical device 168 may be suspended from the ceiling of the air house area (not shown in FIG. 16) or other suitable structural members, and may be remotely located from the air house and spray booth equipment to assure a safe and reasonable distance from any hazardous area or condition.

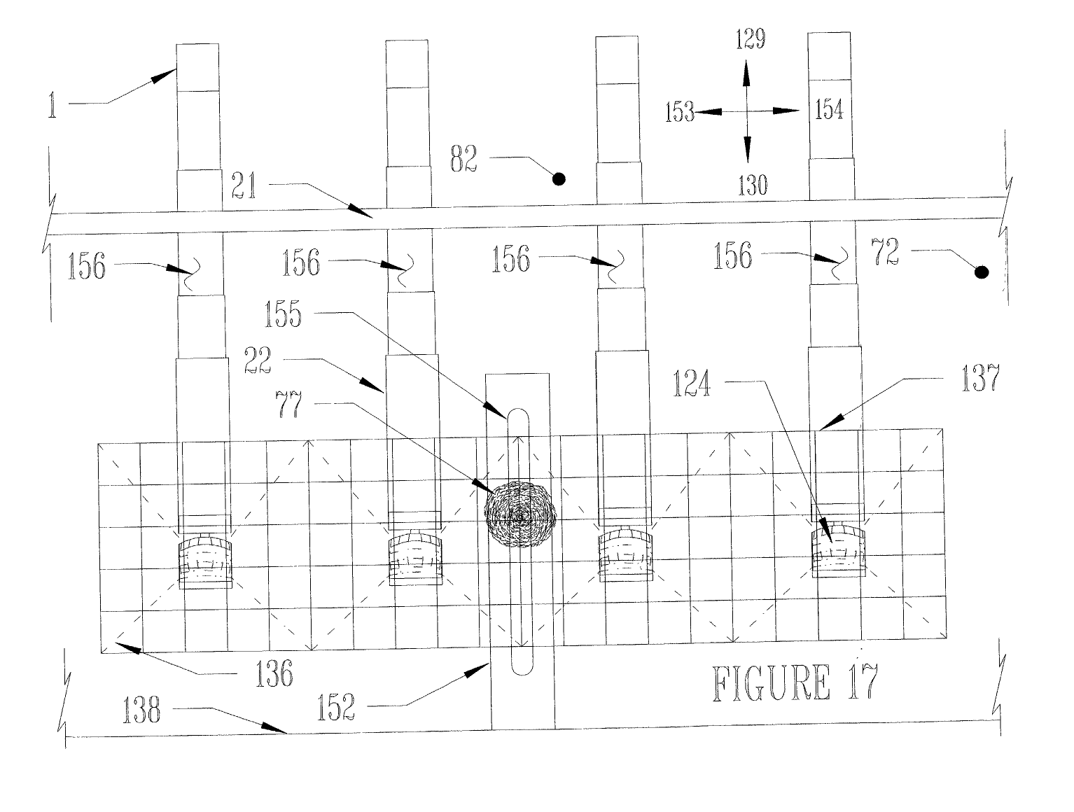

Moving to FIG. 17, multiple wave guide devices 156 are arranged in a horizontal array. The strategic positioning of the wave guide devices 156, and their 1:25 expanded radiant patterns 137, form a contiguous and seamless wall of expanded radiation 136 for industrial processing use within the hazardous spray booth 72. The illustration shows four wave guide devices 156 that are dispersing their expanded electromagnetic radiation 136 toward the observer, and the radiant pattern 137 exists upon an imaginary vertical plane that resides perpendicularly in front of the wave guide devices 156. Automatically actuated powder spray application equipment 152 is positioned between the wave guide devices 156. The electrostatically charged powder cloud 77 is visible between the second and third wave guide devices 156. An up 129 and down 130 vertical motion of the spray application equipment 152 facilitates the application of the coating material contained in the electrostatically charged powder cloud 77 upon a target object that may be conveyed in front of the reciprocating powder spray application equipment 152. A slot 155 is shown that accommodates the movement of the powder delivery tube (not visible in this view) and the powder turbo-bell device (not visible in this view). The convex reflective surfaces 124 can be clearly observed in this view. The lower delivery end 22 of all four wave guide devices 156 have been positioned at the same height from the floor 138 of the spray booth area 72. The units may also move laterally to the left 153 or laterally to the right 154, manually or automatically, for purposes of repositioning or for tracking a target. The electromagnetic emitter fixture assemblies 1 are shown within the air house area 82.

Turning to FIG. 18, the same wave guide devices 156 as shown in FIG. 17 are illustrated, except in the plan view. The wave guide devices 156 each measure 15″ square (plan view) and emit a 25 square foot electromagnetic emission dispersion 127 at a distance of five feet from the vertical and perpendicular flat target surface 99. All four wave guide devices 156 provide a 100 square foot electromagnetic emission dispersion 127, measuring 5 feet high×20 feet long. The automatically reciprocating powder coating application equipment 152 measures approximately 18″×60″ in this plan view. Note that the electrostatically charged powder cloud 77 is mostly submerged in the electromagnetic emissions 10 and 127, yet none of the emissions 10 and 127 have come into contact with any of the spray application components, such as the powder delivery tube 160 or the turbo-bell device 159. The expanded and dispersed radiant emissions 127 remain uninterrupted before, during, and after the application of the powder coating material within the powder cloud 77, and is continuously in intimate contact with the target surfaces 99 in process. If desired, the wave guide devices 156 may be used to emit higher density infrared radiation 10 directly into the powder cloud 77 in order to heat the powder coating particles in transit from the powder spray turbo-bell 159 to the target surface 99. As previously stated, the air that is mixed with the powder material within the powder delivery tube 160 may be heated to reduce the Delta T between the powder particles and the target surface 99 temperature. The combination of pre-heated powder delivery air, radiant energy 10, and the maintenance of ideal product surface temperatures can cause the powder to coalesce immediately upon contact with the heated target surface 99. Taken a step further, the powder can be pre-coalesced and liquefied in transit, creating a wet powder spray that emulates liquid paint coating characteristics. The new art contained in this invention are in sharp contrast to the current processing methods of today that employ separate equipment mentality and no provisions for maintaining the surface temperatures of thermally sensitive substrates, such as wood and wood-based products.

Remaining with FIG. 18, the wave guide devices can be moved laterally to the left 153, laterally to the right 154, in a direction away 157 from the target surface 99, in a direction toward 158 the target surface 99, and can be rotated clockwise 132 or counterclockwise 133, manually or automatically, for purposes of repositioning and/or for track a moving target. The plan view illustration shows the outer spray booth partition 21 wall behind the wave guide devices 156.

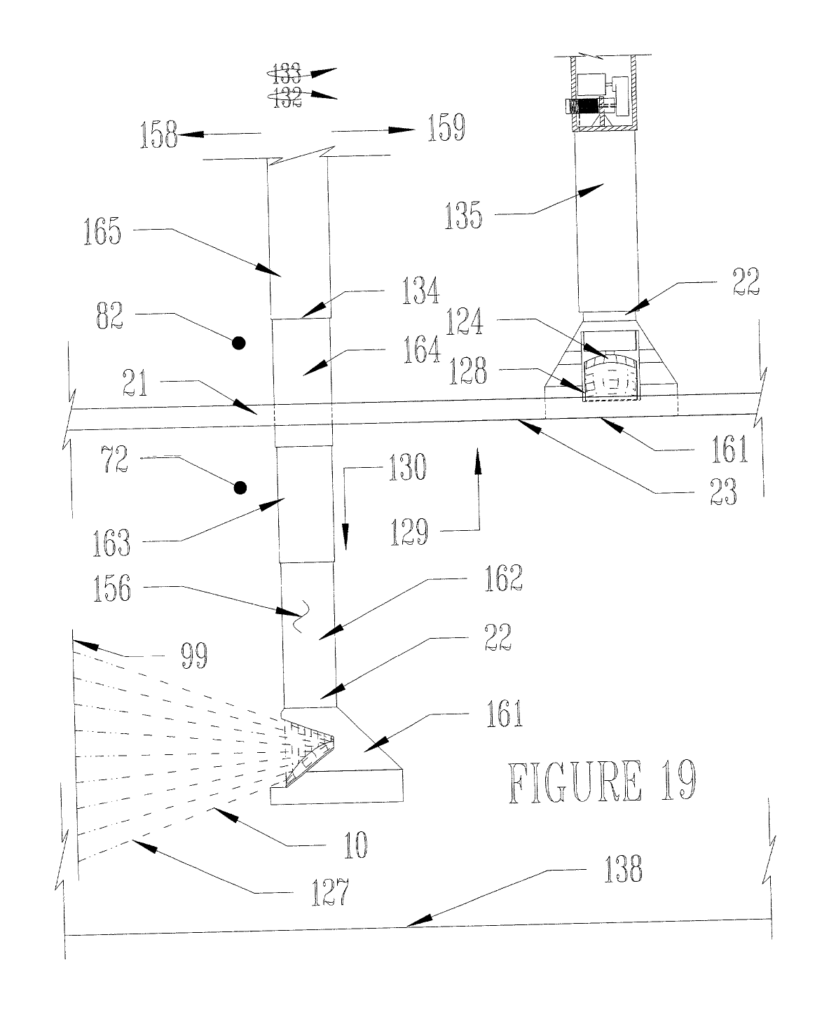

Moving now to FIG. 19, an aspect of the invention is illustrated within the spray booth area 72. The extended wave guide device 156 shows the turret cover 161 that is attached to the delivery end 22 of the wave guide device 156. A series of telescoping and interlocking tube stages 134 are shown, where the delivery end 22 is covered by a stage one 162 tube that telescopes into a larger stage two 163 tube, which telescopes into another larger stage three 164 tube, and finally into yet another larger stage four 165 tube. The interlocking stages 134 cover inner telescoping wave guides and/or the lift cables to protect against the accumulation of dust, dirt, and unwanted particulate matter. The telescoping and interlocking stages 134 also prevent personnel within the spray booth area 72 from touching the inner workings of the wave guide devices 156. The extended wave guide device 156 shows electromagnetic energy 10 and a strategic dispersion of electromagnetic radiation 127 being emitted from the wave guide device 156. The telescoping and interlocking stages 134 of tubing can move in an upward direction 129 or a downward direction 130. The wave guide devices 156 can also move laterally in a direction away 159 from the target surface or in a direction toward 158 the target surface. The telescoping wave guide device 156 can also be rotated in a clockwise direction 132 or in a counterclockwise direction 133 for tracking the target or for fine tuning of positioning, manually or automatically. The entire telescoping wave guide device 156 protrudes through the spray booth partition 21 from the air house area 82. The unit on the right side of FIG. 19 shows the telescoping wave guide device 156 fully retracted 135 into the ceiling 23 of the spray booth area 72 with the bottom of the turret cover 161 flush with the ceiling 23 surface. The telescoping wave guide device 156 can be extended downward 130 toward the floor 138 of the spray booth area 72 so that the electromagnetic radiation 10 can be dispersed 127 to the lower extremes of a target surface 99 in process. The convex reflective surface 124 attached to the turret system 128 can be seen within the turret cover 161, which is attached to the delivery end 22 of the fully retracted 135 wave guide device 156.

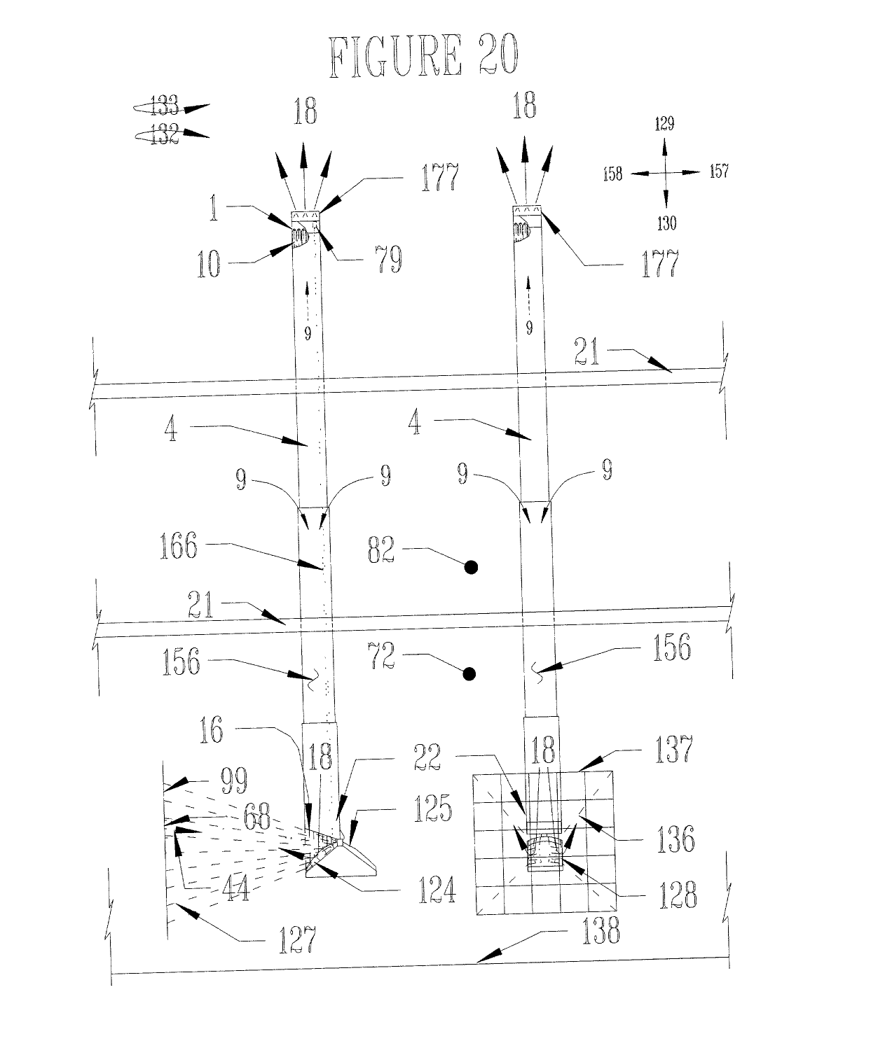

FIG. 20 is an illustration of a variation of the invention, specifically for the method used for cooling fluid flow. FIG. 20 shows an electromagnetic emitter fixture assembly 1 mounted on the upper end of a wave guide device 156 that is intended to transfer electromagnetic radiation 10, such as infrared radiation and/or ultraviolet radiation, into a normally hazardous spray booth area 72 for industrial processing reasons. The electromagnetic emitter fixture assembly 1 contains a plurality of emitter devices, both of which assist in the emission of highly aligned electromagnetic radiation 10 that is directed into the wave guide device 156. The delivery end 22 of the wave guide device 156 then delivers properly aligned electromagnetic radiation 16. A cooling fluid 9 (typically filtered and conditioned air) is inserted into the wave guide device 156 at its approximate midpoint from the air house area 82. The cooling fluid 9 passes into the wave guide device 156 and exits at the delivery end 22 of the wave guide body 4 as exhaust purge fluid 18 at low velocity to keep any particulate matter, such as liquid and/or powder paint material from drifting into the device and from contaminating the convex reflective surface 124 or other reflective surface 125. The cooling fluid 9 that is inserted into the wave guide body 4 within the air house area 82 also travels toward the electromagnetic emitter fixture assembly 1, passes through the fixture assembly 1, carries away waste heat from the fixture assembly 1, then exits the wave guide device 156 in the form of exhaust purging fluid 18. The movement of exhaust purging fluid 9 through the top end of the wave guide device 156 prevents all objectionable heated fluid (often air) from traveling into the hazardous spray booth area 72. The wave guide 156 configuration in FIG. 20 permits all hazardous items, such as electrical wires, unacceptably high temperature surfaces, and otherwise prohibited equipment, to be placed at a minimum safe distance, such as five feet, from the outer partition 21 surface of the air house area 82 and the spray booth area 72. Note that there are no electrical wires within the wave guide device 156 or located within the hazardous spray booth area 72 or within the air house area 82.The telescopic wave guide device 156 is constructed of square, round, rectangular, or ovular shaped tubing. The wave guide device 156 can be telescoped upward 129 or telescoped downward 130 and positioned at a convenient height for use within the hazardous spray booth area 72, and remain at a given position until such time that the operator of the spray booth area 72 desires to modify its height (see FIG. 16 for details about mechanical movement of telescoping device). The wave guides 156 can be manually or automatically move toward 158 or away 157 from the target surface 99, for purposes of repositioning or for tracking a moving target. The entire wave guide device 156 can also be rotated in a clockwise 132 or counterclockwise 133 direction as needed during operation. This may be accomplished automatically through the use of a linear actuator (not shown) or other powered device that is located at a safe distance from the hazardous spray booth area 72. The location of the electromagnetic emitter fixture I end of the wave guide device 156 may be located at virtually any reasonable distance from the spray booth area 72 and the air house area 82, and may be outside of both of these areas as shown, if it is desirable or required to place the electromagnetic emitter fixture 1, or any related electrical wiring, hot surfaces, or devices that could create an electrical spark, or otherwise be a safety hazard, at a specified distance away from the furthest outside partition of the air house area 82.

The electromagnetic radiation 10 is transferred from the fixture 1 through the wave guide body 4 and then exits the wave guide device 156 at the delivery end 22. The aligned electromagnetic radiation 16 is then redirected at various strategic angles for use within the spray booth area 72. The radiation 16 is also strategically expanded 136 over a significantly larger area in order to spread the energy over a larger target surface 99 area during its use within the spray booth area 72. This is accomplished by directing the electromagnetic radiation 16 onto a strategically designed convex reflective surface 124. The convex reflective surface 124 may alternatively be concave, flat, or any combination of these, in order to efficiently and strategically redirect the electromagnetic radiation 16 as needed for processing within the spray booth area 72. The said reflective surface may modify the direction of the electromagnetic radiation 16 without expanding it, or may concentrate the electromagnetic radiation 16 into a smaller pattern for increased density per square area of measurement relative to the power density per square area of measurement as measured at the original power source within the electromagnetic fixture 1. FIG. 20 features an expansion factor of 1:25, where the electromagnetic emissions 10 from a fixture 1 measuring one (1) square foot is expanded to a pattern of radiation 137 measuring twenty-five (25) square feet at a distance of five feet when directed toward a flat vertical target surface 99. The side view of the wave guide device 156 (on left of FIG. 20) illustrates the - dispersion 127 of aligned electromagnetic radiation 16 as viewed from the side of the device. The front view (right in FIG. 20) illustrates the pattern of electromagnetic radiation 137 when striking a theoretical flat and vertical surface 99 that is generally positioned perpendicularly to the radiant emission 16 that is dispersed 127 from the convex reflective surface 124. The reflective surfaces 124 and 125 within the turret system 128 will be highly reflective to the particular peak wavelengths of electromagnetic radiation 16 that may be used. If aligned process radiation 16 is infrared radiation, the convex reflective surface 124 and additional reflective surfaces 125 will likely be plated with 24K gold in order to maximize reflectivity of said radiation 16 and to minimize the absorption of infrared energy by the reflective surfaces 124 and 125. The gold can be deposited upon the reflective surfaces 124 and 125, where the reflective surface's substrates are constructed from a material possessing rapid thermal conductivity, such as aluminum, copper, stainless steel, or a composite material, including ceramics and/or metal and ceramic alloys (cermet). It should be noted that during the continuous delivery of high density electromagnetic radiation 10, specifically within the infrared spectrum, the wave guide body 4 and the reflective surfaces 124 and 125 that redirects and possibly modifies the radiant pattern of electromagnetic radiation 137 shall remain within temperatures that are acceptable for use within the hazardous spray booth area 72. Infrared radiation is not heat, but only an energy that is capable of producing heat with an object that is capable of absorbing the infrared energy. If absorption of the infrared radiation is low, then the temperatures generated within the wave guide body 4 and convex reflective surface 124, and the additional reflective surfaces 125 will be low. The substrates to the reflective surfaces 124 and 125 within the turret system 128 shall be capable of efficiently conducting unwanted heat build-up within said devices away from the reflective surfaces 124 and 125 to maintain acceptable surface temperatures of the wave guide device 156 for safe use within the hazardous spray booth area 72. The convex reflective surface 124, the additional reflective surfaces 125, and their substrate structures may be air and/or water cooled to assist in the maintenance of acceptable equipment surface temperatures.

Remaining with FIG. 20, a method for measuring the temperature of a target surface 99 is illustrated. An infrared non-contact thermometer 79 is strategically positioned within the electromagnetic emitter fixture assembly 1 so it may receive long wave infrared 44 energy that is emitted from a specific area 68 of the target surface 99 in process. The infrared non-contact thermometer 79 is well known within the relevant industry, and often contains a lens system to focus the long wave infrared 44 emissions from the target surface 99 into the said instrument. The illustration shows a narrow field of view 166 that is used to collect the long wave infrared 44 radiation that is emitted from the specific area 68 of the target surface 99. The long wave infrared 44 from the specific area 68 of the target surface 99 also strikes the same convex reflective surface 124 simultaneously to the more powerful electromagnetic radiant energy 10 that is used for processing the target surface 99. The long wave infrared 44 radiation that is emitted from the specific area 68 of the process surface 99 travels at approximately the speed of light to the convex reflective surface 124 and is reflected into the telescoping wave guide 4, but is generally traveling in the opposite direction as the electromagnetic radiation 10 energy that is used for processing the target object 99. The long wave infrared 44 radiation that is emitted from the target surface 99 is generally in the peak wavelength range of 7 to 20 microns in length, where the higher the temperature of the target surface 99, the shorter is the peak wavelength of the long wave infrared 44 radiation. The spectral response of 7 to 20 microns of the non-contact infrared thermometer 79 is substantially different than the peak wavelength range of the electromagnetic radiation 10 energy that is used for processing the target surface 99, which is typically in a range of 0.76 micron to 7 microns in length. The non-contact infrared thermometer's 79 field of view 166 is positioned to accurately receive the long wave infrared 44 radiation that is emitted from the specific area 68 of the target surface 99 and reflected by the convex reflective surface 124 into the field of view 166 of the non-contact infrared thermometer 79. The peak wavelengths of the long wave infrared 44 radiation that are received and interpreted are directly proportional to the actual surface temperature of the target surface 99. This precise temperature information can be used for open loop and/or closed loop control of the power levels of the electromagnetic radiant energy 10 that is used for processing the target object 99, thereby permitting manual and/or automatic control of the temperature of the target surface 99 in a precise and strategic manner. The electromagnetic radiant energy 10 and long wave infrared 44 energy that are simultaneously present and traveling in substantially opposite directions, at the speed of light, are successfully manipulated by strategic reflection from the same convex reflective surface 124 without conflict. Thus is the nature of electromagnetic radiation, whose coexistence of altered energies in space and time maintain separate, distinct, and interpretable identities. This given natural property enables the simultaneous transfer of substantially different electromagnetic energies 44 and 10 within the same wave guide device 156 for accurately and safely processing a target surface 99 without the need for the placement of electrical wires, or other hazardous items, within the hazardous spray booth environment 72.

The purpose of using a high density electromagnetic emitter fixture assembly 1 and then expanding 136 the high density electromagnetic radiant energy 10 and 16 over a larger area is to minimize the need for a large and contiguous sheet metal structure that would inhibit visual and physical access to the target object 99 in process within the spray booth area 72. Further, it may be desirable to strategically locate the wave guide devices 156 directly adjacent to the electrostatic powder paint cloud (not shown in FIG. 20) so that electromagnetic process radiation 10 and 16 can be applied to the target surface 99 in process before, during, and after the application of the liquid and/or powder coating material. The small size of the wave guide device 156 that expands the powerful electromagnetic radiant energy 10 and 16 emissions from their small fixtures 1 (one foot square in this example) to that of a significantly larger process emission pattern 137 of 25 square feet creates tremendous efficiencies for the size of the processing equipment, its expense, and convenience of location in relation to other critical processing equipment within the spray booth area 72. The modified purging fluid 9 flow escapes both ends of the wave guide device 156, expels hot exhaust purging fluid 18 from the fixture assembly 1 well outside the outer limit 21 of the air house area 82. This configuration facilitates the long distance transfer of electromagnetic radiant energy 10 from a distant and remote location into the hazardous spray booth area 72 and conforms with safety regulations for safe distance placement of hazardous items from both the spray booth area 72 and the air house area 82. The long distance transfer of electromagnetic radiation 10 is accomplished with high transfer efficiency, and will continue to delivery with high transfer efficiency with virtually any practical length of electromagnetic wave guide device 156.

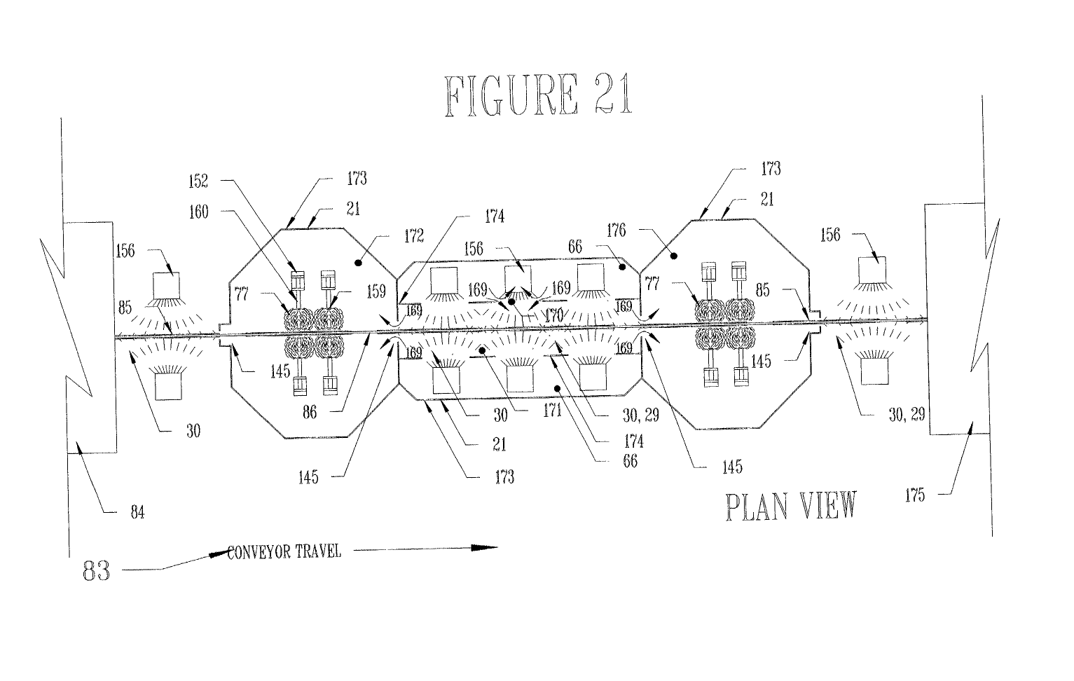

FIG. 21 is a plan view illustration of the invention, and is a processing system variation. FIG. 21 features the processing of hanging parts 85 that are indexed or continuously conveyed by an overhead conveyor 86 in a specific direction 83 as shown. FIG. 21 illustrations assume that the hanging parts 85 in process have been preheated before entering the powder spray and reclaim chamber number one 172 by preheat processing equipment 84. However, preheating of the hanging parts 85 is not necessarily a requirement of the invention as illustrated in FIG. 21. As the hanging parts 85 exit the preheat processing equipment 84 via the overhead conveyor 86, the hanging parts 85 pass a wave guide device 156 (or a plurality of wave guide devices 156) and are processed with infrared radiation 30. The infrared radiation 30 is introduced upon the surface of the hanging parts 85 in order to compensate for thermal losses, thereby maintaining the surface temperature of the hanging parts 85 that was achieved in the preheat processing equipment 84, or for modifying the temperature of the hanging parts 85, as the case may be. The infrared radiation 30 will effectively maintain the temperature of the surface of the hanging parts 85. This reduces the need to heat the surface of the hanging parts 85 to higher than the desired temperature in the preheat processing equipment 84 in compensation for the temperature drop that has historically occurred between the preheat processing equipment 84 and the electrostatically charged powder cloud 77 prior to a method to maintain or modify said surface temperatures as provided by the invention. The hanging parts 85 then pass through an opening 145 and enter the powder spray and reclaim chamber number one 172 via the overhead conveyor 86. The powder spray booth partitions 21 are transparent glass panels 173, but may be clear plastic sheet material. The hanging parts 85 then move to the electrostatically charged powder cloud 77, where the powder coating is applied to the hanging parts 85, via a turbo-bell device 159, powder delivery tube 160, and powder spray application equipment 152. The heated surface of the hanging parts 85 cause the powder particles in the electrostatically charged powder cloud 77 to begin to coalesce upon contact with the surface of the hanging parts 85. The powder material that does not adhere to the hanging parts 85 in the powder spray and reclaim chamber number one 172 is reclaimed for future use by the typical means as known to those who are skilled in the art of powder coating applications. After the application of the powder coating, the hanging parts 85 will continue to travel on the overhead conveyor 86 through an opening 145 in the radiation processing chamber area 171 to be heated with infrared radiation 30 to liquefy the powder and to facilitate its flow out and leveling. Surface temperatures of the hanging parts 85 are monitored both before and after the application of the powder coating through the use of infrared non-contact thermometers 79, not visible in FIG. 21. The infrared non-contact thermometers 79 are integrated with the wave guide devices 156, and can be seen in FIG. 20. A programmable controller interprets feedback from the infrared thermometers 79 to automatically maintain or modify the surface temperatures of the hanging parts 85 in process within adjustable parameters. As the hanging parts 85 move through the powder spray and reclaim chamber number one 172 via the overhead conveyor 86, the said parts 85 are may also be processed with ultraviolet radiation 42, assuming that the coating in process is a UV curable material. Wave guide devices 156 that reside within pressurized supply fluid chambers 66 provide the infrared radiation 30 and the ultraviolet radiation 29. Each pressurized supply fluid chamber 66 contains and supplies a flow of pressurized filtered supply air 169 that travels into each wave guide device 156 and through each radiation port 170 that resides within the air baffle partitions 174. The air baffle partitions 174 form a barrier wall that separates the pressurized supply fluid chamber 66 and the radiation processing chamber area 171 from each other. The pressurized filtered supply air 169 passes through each radiation port 170 to prevent any airborne powder material from drifting into the pressurized supply fluid chamber 66 and from contacting the wave guide devices 156. The infrared radiation 30 and ultraviolet radiation 29 will pass through the radiation port 170 simultaneously to the flow of the pressurized filtered supply air 169 flowing from the pressurized supply fluid chamber 66 to the radiation processing chamber area 171. It should be noted that the air pressure in the pressurized supply fluid chamber 66 will be higher than the air pressure in the radiation processing chamber area 171 under normal operating conditions. The pressurized filtered supply air 169 then travels through openings 145 between the radiation processing chamber area 171 and the powder spray and reclaim chamber number one 172 and the powder spray and reclaim chamber number two 176. It should be noted that the air pressure in the radiation processing chamber area 171 will be equal to or higher than the air pressure within the powder spray and reclaim chamber number one 172 and the powder spray and reclaim chamber number two 176 under normal operating conditions. The flow of the pressurized filtered supply air 169 through said chambers facilitates the movement and capture of stray powder material and reduces thermal damage to powder material that is intended to be reclaimed within the powder spray and reclaim chamber number one 172 and the powder spray and reclaim chamber number two 176. The flow of the pressurized filtered supply air 169 into the wave guide devices prevents heated air from entering the pressurized supply fluid chamber 66, the radiation processing chamber area 171, the powder spray and reclaim chamber number one 172, and the powder spray and reclaim chamber number two 176. Elevated air temperature is not desirable with the powder processing system FIG. 21, as it will create thermal contamination of the powder material and reduce the percentage of successfully reclaimed powder material for future use. The flow of pressurized filtered supply air 169 into the wave guide devices 156 may be regulated via adjustable air dampers 177 that reside at the top of the wave guide devices 156 above the radiant emitter fixtures. The adjustable air dampers 177 are illustrated in FIG. 20, and are not visible in FIG. 21. The flow of the pressurized filtered supply air 169 into the wave guide devices 156 are in addition to the natural chimney effect that occurs, thereby preventing the flow of all heated air from entering the pressurized supply fluid chambers 66. The infrared radiation 30 and ultraviolet radiation 29 will pass in the opposite direction to the flow of the pressurized filtered supply air 169. The flow of said radiation from the wave guide devices 156 will not be hindered by the reverse flow of pressurized filtered supply air 169, since said radiation is not absorbed or adversely affected by pressurized filtered air 169.

The hanging parts 85 continue to move from the radiation processing chamber area 171, in the conveyor direction 83, through an opening 145 and into the powder spray and reclaim chamber number two 176. The hanging parts are then processed with a second application of powder coating material via the electrostatically charged powder cloud 77 that resides within the powder spray and reclaim chamber number two 176. Excess powder material is also reclaimed in the powder spray and reclaim chamber number two 176 by the current methods known to those skilled in the art of powder coating applications. The hanging parts 85 then travel through an opening 145 at the end of the powder spray and reclaim chamber number two 176 where it exits the powder processing system FIG. 21. Additional wave guide devices 156 supply process radiation prior to insertion into a post-heat processing oven 175. The radiation supplied prior to the post-heating processing oven 175 from the wave guides 156 may be infrared radiation 30 and/or ultraviolet radiation 29. The post-heat processing oven 175 may supply heated air, infrared radiation, ultraviolet radiation, or any combination of these processing variables, to the hanging parts in process 85.

The radiation emitting devices are maintained at a safe distance (typically a minimum of five feet) from the outer limit of the spray booth partition 21 of the powder processing system FIG. 21 permitting the safe execution of one or more of the objectives of the invention. Heated air is prevented from entering the system, except for heated air that is generated by the contact of the pressurized filtered supply air 169 with the heated surfaces of the hanging parts 85 in process. However, it should be noted that the prior art typically required the overshooting of temperature of the hanging parts 85 by significant margin, often 60° to 100° F. within the preheating process equipment 84 in anticipation of thermal degradation of the temperature of the hanging parts 85. The prior need to overshoot the target temperature has been eliminated, additionally reducing the amount of undesirable heated air that is generated with the powder processing system.

The ability to maintain the surface temperature of wood-based substrates between the exit of the preheating oven and the actual application of the powder material eliminates the need to intentionally overshoot the ideal desired substrate temperature (such as 200° F.). This reduces cracking problems and preserves valuable surface moisture levels within and upon the wood-based substrate. The manufacturer, because of this feature, may utilize less expensive grades of wood substrates in the manufacture of their products, thereby reducing their overall cost of manufacturing.

The invention also permits the application of multiple coatings of powder material within the same powder processing system to achieve greater coating mil thickness. The technology can flow the powder between multiple spray applications within one powder system without creating a high ambient heat problem within the powder booth environment. A reduction of heated air within the powder system improves the successful reclaim of powder by preventing it from gelling via unwanted processing heat. The invention safely combines process radiation (IR and/or UV) with the powder spraybooth equipment in order to gain significant processing advantages when processing powder coatings on wood-based substrates.

What I claim as my invention is:

1. A coating spray booth system that provides a means to control the surface temperature of an object in process, relative to the ambient temperature of the spray booth environment, within the outer partition limits of the spray booth environment, extending to a distance of less than five (5) feet in any desirable direction beyond and outside of any outer partition limit of the spray booth system apparatus.

2. A coating spray booth system according to claim 1 wherein the control of said surface temperature of an object in process is maintained before the application of a coating upon the object.

3. A coating spray booth system according to claim 1 wherein the control of said surface temperature of an object in process is maintained during the application of a coating upon the object.

4. A coating spray booth system according to claim 1 wherein the control of said surface temperature of an object in process is maintained after the application of a coating upon the object.

5. A coating spray booth system according to claim 1 wherein the surface temperature of an object in process may be increased before the application of a coating upon the object.

6. A coating spray booth system according to claim 1 wherein the surface temperature of an object in process may be increased during the application of a coating upon the object.

7. A coating spray booth system according to claim 1 wherein the surface temperature of an object in process may be increased after the application of a coating upon the object.

8. A coating spray booth system according to claim 1 wherein the control of said surface temperature of an object in process is maintained before the application of a coating upon the object in process and simultaneously to the application of a coating upon other parts in process within the outer partition limits of the spray booth environment, extending to a distance of less than five (5) feet in any desirable direction beyond and outside of any outer partition limit of the spray booth apparatus.

9. A coating spray booth system according to claim 1 wherein the control of said surface temperature of an object in process is maintained after the application of a coating upon the object within the outer partition limits of the spray booth environment, extending to a distance of less than five (5) feet in any desirable direction beyond and outside of any outer partition limit of the spray booth apparatus and simultaneously to the application of a coating upon other parts in process within the outer partition limits of the spray booth apparatus.

10. A coating spray booth system according to claim 1 wherein the control of said surface temperature of an object in process is maintained during the application of a coating upon the object and simultaneously to the control of said surface temperature of objects in process both before and after the application of a coating upon their surfaces within the outer partition limits of the spray booth environment, extending to a distance of less than five (5) feet in any desirable direction beyond and outside of any outer partition limit of the spray booth apparatus.

11. A coating spray booth system according to claim 1 wherein the control of said surface temperature of an object in process is accomplished by applying electromagnetic energy upon the surface of the said object in process.

12. A coating spray booth system according to claim 1 wherein the control of said surface temperature of an object in process is accomplished by applying electromagnetic infrared energy upon the surface of the said object in process.

13. A coating spray booth system according to claim 1 wherein the control of said surface temperature of an object in process is accomplished by applying electromagnetic infrared energy with peak infrared wavelengths ranging from 0.76 micron to 10 microns upon the surface of the said object in process.

14. A coating spray booth system according to claim 1 wherein electromagnetic energy within the ultraviolet spectrum is applied upon the surface of the said object in process within the outer partition limits of the spray booth environment, extending to a distance of less than five (5) feet in any desirable direction beyond and outside of any outer partition limit of the spray booth apparatus.

15. A coating spray booth system according to claim 1 wherein electromagnetic energy within the ultraviolet spectrum is applied upon the surface of the said object in process before the application of a coating upon the object within the outer partition limits of the spray booth environment, extending to a distance of less than five (5) feet in any desirable direction beyond and outside of any outer partition limit of the spray booth apparatus.

16. A coating spray booth system according to claim 1 wherein electromagnetic energy within the ultraviolet spectrum is applied upon the surface of the said object in process during the application of a coating upon the object within the outer partition limits of the spray booth environment.

17. A coating spray booth system according to claim 1 wherein electromagnetic energy within the ultraviolet spectrum is applied upon the surface of the said object in process after the application of a coating upon the object within the outer partition limits of the spray booth environment, extending to a distance of less than five (5) feet in any desirable direction beyond and outside of any outer partition limit of the spray booth apparatus.

18. A coating spray booth system according to claim 1 wherein electromagnetic energy within the ultraviolet spectrum is applied upon the surface of the said object in process before the application of a coating upon the object within the outer partition limits of the spray booth environment, extending to a distance of less than five (5) feet in any desirable direction beyond and outside of any outer partition limit of the spray booth apparatus and simultaneously to the application of a coating upon other parts in process within the outer partition limits of the spray booth environment.

19. A coating spray booth system according to claim 1 wherein electromagnetic energy within the ultraviolet spectrum is applied upon the surface of the said object in process during the application of a coating upon the object and simultaneously to the control of said surface temperature of objects in process both before and after the application of a coating upon their surfaces within the outer partition limits of the spray booth environment, extending to a distance of less than five (5) feet in any desirable direction beyond and outside of any outer partition limit of the spray booth apparatus.

20. A coating spray booth system according to claim 1 wherein electromagnetic energy within the ultraviolet spectrum and the infrared spectrum are applied to the part in process and exists simultaneously at any point within the outer partition limits of the spray booth environment, extending to a distance of less than five (5) feet in any desirable direction beyond and outside of any outer partition limit of the spray booth apparatus.

21. A coating spray booth system according to claim 1 wherein said parts in process are conveyed on a moving conveyor.

22. A coating spray booth system according to claim 1 wherein said parts in process are conveyed on an indexing conveyor.

23. A coating spray booth system according to claim 1 wherein said parts in process are conveyed on a power-and-free conveyor.

24. A coating spray booth system according to claim 1 wherein said parts in process are conveyed on a variable speed conveyor.

25. A coating spray booth system according to claim 1 wherein said parts in process are conveyed on an overhead conveyor.

26. A coating spray booth system according to claim 1 wherein said parts in process are conveyed on a belt conveyor.

27. A coating spray booth system according to claim 1 wherein said parts in process are automatically conveyed on any conveyor.

28. A coating spray booth system that provides a means to control the rate of thermal expansion within an object in process within the outer partition limits of the spray booth environment, extending to a distance of less than five (5) feet in any desirable direction beyond and outside of any outer partition limit of the spray booth apparatus.

29. A coating spray booth system according to claim 28 wherein the coefficient of expansion within an object in process can be controlled before the application of a coating upon the object within the outer partition limits of the spray booth environment, extending to a distance of less than five (5) feet in any desirable direction beyond and outside of any outer partition limit of the spray booth apparatus.

30. A coating spray booth system according to claim 28 wherein the coefficient of expansion within an object in process can be controlled during the application of a coating upon the object within the outer partition limits of the spray booth apparatus.

31. A coating spray booth system according to claim 28 wherein the coefficient of expansion within an object in process can be controlled after the application of a coating upon the object within the outer partition limits of the spray booth environment, extending to a distance of less than five (5) feet in any desirable direction beyond and outside of any outer partition limit of the spray booth apparatus.

32. A coating spray booth system according to claim 28 wherein the coefficient of expansion within an object in process can be controlled before and/or during and/or after the application of a coating upon the object within the outer partition limits of the spray booth environment, extending to a distance of less than five (5) feet in any desirable direction beyond and outside of any outer partition limit of the spray booth apparatus.

33. A coating spray booth system that provides a means to process the surface of an object in process with electromagnetic infrared and/or ultraviolet energy at any point within the outer partition limits of the spray booth environment, extending to a distance of less than five (5) feet in any desirable direction beyond and outside of any outer partition limit of the spray booth apparatus.

34. A coating spray booth system according to claim 33 wherein the electromagnetic energy is transferred to the part in process by means of a wave guide device.

35. A coating spray booth system according to claim 33 wherein the electromagnetic energy is transferred to the part in process by means of a fluid purged fixture.

36. A coating spray booth system according to claim 33 wherein the electromagnetic energy is transferred to the part in process by means of an explosion-proof and fluid cooled electromagnetic emitter device.

37. A coating spray booth system according to claim 33 wherein the electromagnetic energy is transferred to the part in process by means of a fluid purged and fluid cooled emitter fixture.

38. A coating spray booth system according to claim 33 wherein the electromagnetic energy is transferred to the part in process by means of a telescoping wave guide device.

39. A coating spray booth system according to claim 33 wherein the electromagnetic energy is transferred to the part in process by means of a wave guide that delivers concentrated electromagnetic energy that is strategically expanded and radiated over a larger area.

40. A coating spray booth system according to claim 33 wherein the electromagnetic energy is transferred to the part in process through a wave guide that employs strategic airflow to prevent the intrusion of particulate matter into the electromagnetic energy device.

41. A coating spray booth system according to claim 33 wherein the electromagnetic energy is generated by means of an electrical transducer device.

42. A coating spray booth system according to claim 33 wherein the electromagnetic energy is generated by means of any combustible gases.

43. A coating spray booth system according to claim 33 wherein the electromagnetic energy is generated by means of a hybrid device that utilizes electricity and any combustible gases.

44. A coating spray booth system that consists of a spray chamber and a radiation processing chamber positioned at a distance of less than 60″ from each other with the intent of applying a coating to a part in process in said spray chamber and then effecting a thermal and/or radiation cure to said coating upon said part in process in the radiation chamber.

45. A coating spray booth system according to claim 44 wherein the coating chamber contains automatically operated electrostatic coating application equipment.

46. A coating spray booth system according to claim 44 wherein the coating chamber contains manually operated electrostatic coating application equipment.

47. A coating spray booth system according to claim 44 wherein the coating to be applied in the spray chamber is a powder coating.

48. A coating spray booth system according to claim 44 wherein the coating to be applied in the spray chamber is a liquid coating.

49. A coating spray booth system according to claim 44 wherein the spray chamber and the radiation processing chamber may be physically connected.

50. A coating spray booth system according to claim 44 wherein a plurality of spray chambers and radiation chambers may be arranged in an alternating fashion for the purpose of applying and processing multiple coats of coatings upon a part in process.

51. A coating spray booth system according to claim 44 wherein the parts to be processed are comprised of a wood-based material.

52. A coating spray booth system according to claim 44 wherein the parts to be processed are comprised of a plastic material.

53. A coating spray booth system according to claim 44 wherein the parts to be processed are comprised of a composite material.

54. A coating spray booth system according to claim 44 wherein the parts to be processed are comprised of a material that has a low rate of thermal conductivity.

55. A coating spray booth system according to claim 44 wherein the parts to be processed are comprised of a material that has a high rate of thermal expansion.

56. A coating spray booth system according to claim 44 wherein the parts to be processed are comprised of a material that has a low rate of thermal conductivity and a high rate of thermal expansion.

57. A coating spray booth system according to claim 44 wherein the parts to be processed are comprised of medium density fiberboard (MDF).

58. A coating spray booth system according to claim 44 wherein the coating material applied within the spray chamber can be reclaimed.

59. A coating spray booth system according to claim 44 wherein the radiation chamber contains a separate sub-chamber that houses an electromagnetic radiant energy device.

60. A coating spray booth system according to claim 44 wherein the radiation chamber contains a separate sub-chamber that houses a wave guide device.

61. A coating spray booth system according to claim 44 wherein the spray chamber contains a separate sub-chamber that houses an electromagnetic radiant energy device.

62. A coating spray booth system according to claim 44 wherein the spray chamber contains a separate sub-chamber that houses a wave guide device.

63. A coating spray booth system according to claim 44 wherein the radiation chamber contains a separate chamber that supplies purging air that enters the wave guide device and compliments the chimney effect of air movement while the balance of the purging air simultaneously escapes through a radiation port to facilitate the efficient transfer of electromagnetic energy while preventing the intrusion particulate matter into the separate sub-chamber that houses the wave guide device and to prevent hot air from entering the radiation chamber area.

64. A coating spray booth system according to claim 44 wherein the spray chamber contains a separate chamber that supplies purging air that enters the wave guide device and compliments the chimney effect of air movement while the balance of the purging air simultaneously escapes through a radiation port to facilitate the efficient transfer of electromagnetic energy while preventing the intrusion particulate matter into the separate sub-chamber that houses the wave guide device and to prevent hot air from entering the spray chamber area.

65. A coating spray booth system according to claim 44 wherein the system combines a conveyor, spray booth, coating application equipment, coating material, strategic air flow, and electromagnetic infrared and/or ultraviolet process radiation within the outer partition limits of the spray booth environment, extending to a distance of less than five (5) feet in any desirable direction beyond and outside of any outer partition limit of the spray booth apparatus for the purpose of efficiently coating, heating and/or radiation curing coating materials on wood, wood-based composite material, and plastic parts in process.
